(19) United States
(12) Patent Application Publication
(10) Pub. No.: US 2023/0162711 A1
(43) Pub. Date: May 25, 2023

(54) MODULAR HEADLESS STRINGED MUSICAL INSTRUMENT FOR TRAVEL PORTABILITY WITH ENHANCED SERVICEABILITY AND QUICKLY REPLACEABLE NECK JOINT AND TREMOLO SYSTEMS

(71) Applicant: Takeshi Suda, Yokoshibahikarimachi (JP)

(72) Inventor: Takeshi Suda, Yokoshibahikarimachi (JP)

(21) Appl. No.: 18/069,095

(22) Filed: Dec. 20, 2022

Related U.S. Application Data
(60) Provisional application No. 63/265,783, filed on Dec. 20, 2021.

(51) Int. Cl. G10D 3/095; G10D 3/153; G10D 1/08; G10D 3/12; G10D 3/04

(52) U.S. Cl. CPC G10D 3/095; G10D 3/153; G10D 1/085; G10D 3/12; G10D 3/04

(57) ABSTRACT

A three-piece modular stringed instrument comprising a body module, a neck module, and a tremolo module with expedited assembling and disassembling steps enabled by the design of a tremolo system to expand its use of the pivotal string tension control in synergistic combination with an additional leveraging string tension control at the neck end of the strings, as well as a streamlined neck joint system comprising an oversized neck pocket, a self-adjusting axial coupling, and an adjustably static side-to-side neck clamping structure. The saddle design of the tremolo system comprises the generic machine tuners for conventional electric guitar instruments on a modular headless guitar format with conversion functionality between a full tremolo-enabled configuration and a hardtail configuration.

### FIELD OF THE INVENTION

The present art pertains to electric guitars and other stringed musical instruments and various components thereof. More specifically, the present art pertains to a headless modular electric guitar or any such musical instrument as is arranged to be readily disassembled into a plurality of independent modules chiefly for portability and to be readily assembled or reassembled into any such functioning and playable instrument.

### BACKGROUND OF THE INVENTION

The guitar has been one of the most popular instruments, if not the most, for the past few centuries thanks to its multi-timbral capability and the singing quality of the melody performed on the instrument both available in reasonably portable dimensions and weight of the instrument. In particular, electric guitars have significantly contributed to the popularity of music today since their invention in the mid-twentieth century, as they are designed for electric amplification through options of signal processing, and thus can cater to a variety of instrumentations and their increasingly sizeable audiences by scaling the amplification up or down as appropriate. As today's digital technology has allowed for the virtualization of a significant part of the electric signal chain of the instrument, there are extremely portable yet capable options made available for the signal processing and amplification of the output signal of the electric guitars, allowing for the instrumentalists to take advantage of the public address systems available on-site without bringing their own physical amplification systems, and therefore without the inherent risks of damage or failure of any such amplification systems. Meanwhile, the electric guitar instrumentalists of today or in the history thereof overwhelmingly prefer or have preferred the designs of more conventional guitars that have made the history of popular music to the later and more portable alternatives. As such, the vast majority of the electric guitar instruments have closely maintained their historically defined size measurements and designs without any additionally portable functionality, while the remainder of the electric guitar signal chain has been digitally virtualized in a personal computer or smart device without any measurable physical dimensions. Albeit any virtualized guitar cannot be an alternative to the physical electric guitar instruments for the instrumentalists skilled in traditional electric guitar performances, the majority preference to the historic instruments is the single longest standing roadblock before its next logical step towards downsizing which would maximize the mobility of the instrumentalists while taking advantage of the downsized signal processing and amplification.

The preferred conventional electric guitars comprise a neck, a body, and a set of six or more strings. The typical joining methodologies of the neck and the body comprise so-called “set-in” wherein the neck is permanently or non-detachably attached to the body with an adhesive agent or other mechanical means, so-called “bolt-on” wherein the neck is semi-detachably attached to the body with a plurality of wood screws disposed through a supporting structure or any other threaded mechanical means, and “neck-thru” wherein the neck is extended through the length of the body and constitutes an integral part of the body. The neck comprises a fretboard longitudinally overlaying the neck and facing the strings, a headstock at the outermost end thereof, and a heel at the back of the opposite end of the headstock. The neck further comprises a plurality of machine tuners on the headstock, a plurality of frets on the fretboard periodically disposed across the length thereof, and a nut at or in the proximity of the limit between the fretboard and the headstock. Of all the joint variations, the bolt-on joint comprises one or a plurality of wood screws disposed through a metal neck plate or one or a plurality of other reinforcing structures, body, and into the mounting surface of the neck at the proximity of the heel thereof, wherein the helical threads of the screw secure the neck onto the body. Typical electric guitar strings are made of steel and comprise a ball-end at one end or less typically both ends to facilitate the replacement of the strings, while the other electric guitar strings comprising steel, nylon and fluorocarbon strings used for the electric guitars do not comprise any such ball-end as needs to be removed upon installation or as is not required for installation to an instrument, or otherwise as needs to be attached or configured by a knot in order to install on an instrument. An installed string is loaded with adjustable tension. One end of a string is attached to the peg of the machine tuner for tension adjustment mounted on the headstock at the end of the neck, while the other end of the string is attached to a saddle mounted on the body. Further, the set of strings is held in an array of grooves on a nut and another array of grooves at a bridge mounted at the defined position on the body under the set of strings in the proximity of the saddle. The tensions of the strings are adjusted to produce the desired tonal pitches by the corresponding machine tuners which raise the pitch higher by increasing the tension or lower by reducing the tension. The bridge and the saddle may optionally constitute, most typically, an integrated tremolo bridge assembly for a synchronized tremolo system or, less typically, one of the other kinds of tremolo system which may be disposed on the bridge, saddle, or across the bridge and saddle. A typical tremolo system is operated with an operating handle or whammy bar to allow instrumentalists to pivotally modulate the tension of the strings and therefore the sonic frequencies produced by the strings on the fly. The tremolo system typically comprises a bridge assembly, a lever structure comprising a base plate and a block, one or a plurality of fulcrum members to pivotally hold the lever structure of the system on a supporting structure of the body, one or more tension or compression springs counterbalancing against the string tension, and a whammy bar, and pivotally mounted by means of a plurality of studs, fixing screws, spring claw plate and other supporting structures on the body. The bodies of the electric guitars enabled with a tremolo, inter alia a synchronized version thereof, most typically comprise one or a plurality of recesses or cavities of significant volume that are not found on the other electric guitars configured without a tremolo, or “hardtail” electric guitar instruments, in order to accommodate the tremolo system within the body, affecting the tonal quality of the instruments. Most of the tremolo systems are arranged to hold the strings in tune with the tension of the strings on one end of the lever structure and the counterbalancing force of the springs on the other end thereof being in balance. The instrumentalists typically actuate the system by applying a variable or constant force to the whammy bar, pressing down to the body or pulling up away from the body with their right hand in the proximity of the picking or strumming position over the strings on the body to cause an imbalance between the string tensions and the counterbalancing springs, thereby modulating the tensions of the strings and continuously bringing the pitches of the strings to higher or lower pitches than are tuned. The tremolo system resumes the balance between the string tensions and the counterbalancing springs when the instrumentalist releases the force applied on the whammy bar, after which the strings are brought back in tune as the lever regains the balanced position. The body further comprises one or a plurality of electronic circuits to convert the physical vibration of the strings to an electronic signal, adjust the signal, and then send the signal through a pair of output electronic terminals with or without such adjustment. The electronic circuit comprises a plurality of components optionally including without limitation one or a plurality of pickup microphones, resistors, capacitors, inductors, transformers, transistors, volume control assemblies, tone control assemblies, strips of lead wire, ribbon cables, hand-operated switches, circuit boards, shielding components, grounding components, integrated circuits, liquid crystal displays, light emitting diodes, power battery components, integrated radio-transmission systems such as Bluetooth signal transmitter, and output terminal components for removable audio cables, radio transmission systems, Universal Serial Bus (USB) connections, and TOSLINK connections. Conventional electric guitars may be configured as per a headless structure wherein the headstock of the guitar is unrecognizably minimized to the extent that the headstock component only includes one or a plurality of string attachment components that is/are generally integrated with the nut and without the set of machine tuners, and wherein the tuning functionality is solely provided at the saddle or bridge end of the set of strings with versions and variations of custom components specifically designed for the headless configuration of guitars.

Of all the features of the conventional electric guitar instruments and other stringed instruments as aforementioned, the neck joint, the nut and the bridge represent the criticality that defines the tonal characteristic of the guitar and other instruments as to how the vibration of the strings are dynamically transferred to the body to resonate. Among the presented options, the most popular conventional electric guitar instruments today comprise a bolt-on or set-in neck joint, a plastic or bone nut, and a metal bridge.

The portable electric guitars include a design or system to reduce the measurements of the conventional electric guitars to further facilitate the compact portability or storage or both of the guitar by means of downsized designs as, or a plurality of quickly detachable modules to be re-attached into, or a quickly foldable structure to be unfolded into, a playable electric guitar instrument. Some of the embodied portable electric guitars comprise neck and body modules that make use of the string tension to reinforce the sturdy neck-body joint as the string tension is generally applied in such a way that pulls the neck and body modules together.

Of such popular optional design and system formats as aforementioned, the downsized designs comprise significantly different body sizes, body resonance and optionally shortened scale length or effective length of the strings for the players to re-orient. To compensate for the difference, some of the downsized designs include one or a plurality of detachable modules to outline the shape of more conventional designs, making them a sort of modular designs comprising an integrated body and neck module and one or a plurality of frame modules outlining the conventional body shape. While modular designs of this kind achieve lighter and laterally advantageous portability at the cost of more conventional body resonance, their longitudinal measurement remains comparable to the conventional full-sized instruments that may not conform to applicable luggage regulations and requirements in the course of transportation thereof, so that these specific types of modular approach are auxiliary and are of “downsized” instruments in spirit. Another type of modular design includes detachable neck and body modules to conform to any such luggage regulations to be removably reattached to configure instruments with conventional body size and its resultant tonal quality, but at the cost of additional steps to attach and detach the body module and the neck module which often include removal and reinstallation of the string tension using conventional machine tuners. The collapsible designs facilitate such attaching or detaching steps by maintaining the connection between the body and the neck in a collapsible or foldable manner which less often includes removal and reinstallation of the string tension with conventional machine tuners, but more often includes complex mechanisms compared with the modular designs. The complex mechanisms may expose the instrument to additional risk of damage and may result in tonal quality further deviating from the conventional design with significantly different key parts or components from the conventional alternatives.

Meanwhile, the acceptance of the portable guitars as more portable alternatives by instrumentalists who are mainly playing the other non-portable conventional electric guitars is subject to a variety of aspects thereof, comprising the components that best preserve the tonal quality, play-ability, serviceability, and customizing options with the replacement parts and components made available for the other non-portable conventional electric guitars. For the foldable and modular alternative formats, because the alternative formats have the advantage that can allow for achieving comparable body dimensions and therefore resultant tonal quality to the conventional instruments, the acceptance largely depends on the critical components comprising the neck joints involved in the streamlined steps to detach or collapse and to re-attach or unfold, wherein the modular designs are even more advantageous to achieve the comparable tonal quality of the conventional bolt-on design over the foldable or collapsible formats that often comprise more complex additional parts or components, further deviating from the conventional designs by accommodating any such parts or components occupying more space inside the instruments.

For the modular, foldable, and collapsible designs, several attempts have been made to streamline such steps by introducing an increased number of non-generic or non-conventional components which are designed exclusively for a particular portable embodiment. Thanks to such non-conventional components, some of the attempts have achieved extremely streamlined assembling and disassembling, folding and unfolding, or extending and collapsing steps with the increased number of mechanically movable and statically affixed parts comprising such non-conventional or non-generic components. However, any such increased number of parts in the exclusive and often complex components not only represents increased chances of failure or accidental damage, but also introduces degraded serviceability and accessibility of replacement components and parts thereof in case of failure or accidental damage thereof, due to the complex nature of the increased number of mechanically movable or pivotal parts and statically affixed parts. The damage-resistant durability through transportation and the resiliency against any such failure and damage, that is to say, the accessibility of replacement components and parts and serviceability thereof in case of failure or damage at the travel destinations are highly desired by both vocational performers and leisure hobbyists for their musical instrument embodied for the purpose of portability, as any such failure or damage is actually emerging, or as the insurance for peace of mind.

Furthermore, the tonal quality of the conventional non-portable electric guitars comprising a bolt-on feature is characterized by the optimal wood-to-wood contact between the body and the neck by means of a plurality of wood screws and tight-fitting neck pocket accepting the neck thereof as well as its resultant body resonance. However, the aforementioned non-conventional components comprise, as a whole or in significant part, metal-to-metal fixation or other non-conventional fastening or fixation of the quickly removable or collapsible body and neck, resulting in the tonal characters deviating if not degrading more or less from the generally preferred conventional non-portable electric guitars comprising a bolt-on feature. The conventional tight-fitting neck pocket also contributes to the stable tuning of the strings on the instrument, or the prevention of the strings from tuning modulation, or detuning, resulting from the neck being displaced in the range of the possible play in the neck pocket.

However, the tight-fitting neck contradicts the concept of facilitated assembling and disassembling steps of the portable embodiments of the traditional guitars, and may represent a risk of damage if not handled by a skilled guitar builder or service personnel. The several attempts historically made to achieve the equivalent tonal quality and tuning precision to the conventional tight-fitting neck pocket have yet to see a version which sufficiently streamlines the assembling and disassembling being frequently performed as the portable travel instruments by the traveling instrumentalists, at the same time sufficiently contributing to the precision and stability of the tuned strings of the portable travel versions of the instrument for performances.

Four identified issues derived from the trade-off relationship include the tuning instability and deteriorated tonal quality of the looser neck pocket trading off against increased efforts and risk of damage involved in assembling and disassembling steps of the tighter neck pocket. The solutions employing extensive use of non-conventional and often complex and exclusive metal components and parts as found among the several attempts made have overwhelmingly focused more on maximally decreasing the assembling and disassembling efforts at the cost of the other three with the further additional cost of reduced damage resistant durability through the transportation and reduced resiliency against the failure and damage due to increased use of more complicated and less accessible non-conventional components and parts.

In addition to any such contradiction regarding body-to-neck joint systems, conventional tremolo systems represent a technical challenge to introduce in portable electric guitars comprising detachable neck and body modules. The difficulty is centered around the embodiment approach to mounting the tremolo system which is designed and embodied for non-portable electric guitars to the portable modular or foldable embodiments on an as-is basis, with little to no reasonable consideration to any such modular portable feature.

Albeit no tremolo system has been specifically designed for the modular embodiments, there are some available tremolo systems, inter alia such systems for headless guitars that are preferably suitable for modular portable electric instruments. However, the suitable tremolo systems also comprise significantly more exclusive components and parts than their more traditional alternatives, representing a disadvantage against the damage-resistant durability through transportation and reduced resiliency against the threatened failure and damage that should be preferably alleviated altogether for traveling instrumentalists.

More specifically, the tremolo systems for conventional non-portable electric guitars often call for additional labor-intensive steps and multiple tools for its removal, so that the travel instruments are folded or disassembled with the strings attached to one or both of the neck and body via tremolo of the instruments. However, it is known that any such string, inter alia when it is a steel string, remaining attached on the folded or disassembled body, neck or both are exposed to significantly more risk of string damage the consequence of which is the replacement of the strings, either individually or more often as a set.

Also, more specifically regarding the tremolo systems for headless guitars, with limited alternatives available for more traditional configurations, the systems are most often paired with a nut or nut assembly made of metal as is required by the designs thereof, especially the designs with string locking capability at the nut, with or without “passive” contribution to the facilitated removable attachment to the neck. While the bridges for electric guitars are made of metal more conventionally, the nuts for the most popular conventional electric guitars are made of plastic resin or animal bone material that characterizes the traditional tonal character of the instrument. As such, the tremolo systems for headless guitars most often represent a critically perceivable deviation from the traditional tonal quality of the electric guitar which allows for wider nut options for different tonal characters including but not limited to brass and other metal materials. To best support the conventional tonal quality of the electric guitar for modular portable instruments, the instrument should ideally allow traditional nut options with removably attachable strings in a facilitated manner.

Meanwhile, the functionality of the tremolo systems is such that the pitch modulation is achieved by the pivotally leveraged mechanism to increase, reduce or auto-recover or otherwise control the string tension which must also be controlled likewise in the assembling and disassembling steps of the modular embodiments of travel electric guitars.

### BRIEF SUMMARY OF THE INVENTION

Considering all such situations as identified in the preceding Background section, the present art provides an overall design format of a modular portable headless electric guitar and other stringed instruments comprising a streamlined neck joint system solution to optimally reconcile the identified contradiction regarding the neck joint system, as well as a purpose-built tremolo system solution for modular portable electric guitar and other instruments, featuring fewer and more streamlined exclusive parts and components which make it possible to optimally and strategically employ the parts and components for non-portable conventional electric guitars in order to enhance the streamlined assembling and disassembling steps of the modular electric instruments together with the neck joint solution without degrading the damage resistant durability through the transportation and the resiliency against the failure and damage.

The neck joint system solution in the present art focuses on the mechanism of its assembling and disassembling steps to provide a single reconciling solution with fewer and more streamlined additional non-conventional components and parts to address all four identified issues with no or nominally additional setback.

The tremolo system solution in the present art is a purpose-built system for the modular guitar and other instruments offering cleaner re-attachably detaching capability, and focuses on the pivotally leveraging functionality of tremolo systems to reduce, resume, and otherwise control the string tension in the course of its usual operation as well as the streamlined neck configuration of the headless guitars, and facilitates the assembling and disassembling steps of the instruments by providing two actively and synergistically leveraging steps to assemble and disassemble, one at the tremolo system and the other at a neck-end lever structure on the top end crown of the neck module.

More specifically, the instruments of present art provide the neck-side ends of the strings with the same pivotally leveraging functionality as the tremolo systems for the string tension, and actively engage the neck-side functionality, together with such functionality of the tremolo system, in the assembling and disassembling steps of the instrument, in order to further and synergistically expedite the steps, in the same spirit of employing fewer and more streamlined additional non-conventional components and parts.

The present art further provides other advantageous features for the luthiers and traveling instrumentalists, including without limitation, customizing options comparable to the conventional non-modular electric guitars with a broader range of alternative components readily available on the market globally, and streamlined conversions between a tremolo-enabled full configuration and a hardtail configuration without tremolo functionality.

The aforementioned comparable customizing options, however often overlooked, are of significant advantage for the portable designs, because the broader options comprise updated versions of any such components, be it the latest esthetical upgrade or more technically advantageous features becoming available for the conventional electric guitars, liberating the instrumentalists from a sort of “manufacturer lock-in” situation wherein the instrumentalists are required to wait for upgrades before purchasing the highly complex parts and components exclusively from the manufacturer of their instruments.

To provide a solution for three of the four identified issues on the neck joint system, the instrument comprises an oversized cavity for the bolt-on neck joint, or “neck pocket” having back and two side longitudinal walls and a bottom lateral surface. The surfaces optimally counterfacing the corresponding surfaces of the neck module only include the back wall and the bottom surface, as it has oversized width between the two side walls enough for the walls to avoid contacting the corresponding surfaces of the neck module.

The cavity comprises two structures to hold the neck module in position, including a sagittal or front-to-back axial coupling structure in the proximity of the laterally medial top end of the cavity, and a transverse clamping structure around the bottom end of the cavity.

The axial coupling structure provides a fixed transverse position with a self-adjustable longitudinal position and allows the neck module to radially shift to a calibrated position. To allow the entry of the axial fastener structure on the neck module into the axial coupling structure on the body module, an open-ended slot is provided at the medial top end of the cavity extending downwardly to the central part of the cavity.

The transverse clamping structure provides an adjustably limited width at the bottom end of the side walls to clamp the neck module at two side surfaces of the cuboid bottom tip thereof, wherein two clamping points provide two laterally fixed positions at the bottom of the neck module. The position of the limited width is adjustable within the oversized width of the cavity.

By adjusting or calibrating the transverse position of the limited width against the transverse fixed position of the front-to-back axial coupling structure at the top end of the cavity, the radial angle of the neck module position against the body module can be calibrated around the front-to-back axis provided by the axial coupling structure which is still longitudinally self-adjustable.

Two transverse clamping positions defined by the transverse clamping structure and the axial position defined by the axial coupling structure represent the largest triangular formation available within the back wall of the cavity, wherein the segment between the clamping positions represents the base of the triangle and the axial position represents the top vertex, providing a rigid joint structure without any play between the neck module and body module to ensure the absence of tuning instability due to the removable joint system.

The neck module is vertically inserted from the top down along the back wall of the cavity without any friction against the side walls which do not limit but guide the neck module into the cavity, and with negligible friction against the counterfacing back wall up to the transverse clamping structure where the neck module is finally pressed into the limited clearance of the transverse clamping structure with additional force across a marginal segment of the overall longitudinal travel into the cavity to be set at a calibrated position. The neck module is vertically removed out of the cavity by firstly pulling the neck module upwardly out of the clamping structure for a marginal segment with additional manual efforts, and thereafter frictionlessly for the rest of the travel. Thus the efforts required to attach a neck to the conventional tight-fitting neck pocket as well as the inherent risk of damage thereto are not completely eliminated but strategically minimized without allowing for any tuning instability due to the removable joint system.

On the side walls, the area of wood-to-wood contact in the cavity has been completely lost to marginalize the assembling and disassembling efforts. On the back wall, the area of wood-to-wood contact is further marginally lost to allow the axial fastener structure to enter into the axial coupling structure which in turn ensures the strength of the contact across the major area of the back wall.

With respect to the remaining wood-to-wood contact area on the bottom surface, the contact is not structurally well-attended on conventional bolt-on joints, as the vast majority of the bolt-on joints comprise three to four wood screws disposed front-to-back and thus the vertical position of the neck is not effectively adjustable to ensure the wood-to-wood contact with sufficient pressure on the bottom surface to improve or in any way influence the tonal quality.

Meanwhile, the instrument of present art ensures the optimal wood-to-wood contact as the axial coupling structure allows for self-adjustment of its longitudinal position as the string tension constantly pulls the body module and neck module and therefore the two counterfacing surfaces together, and as the open-ended slot is disposed with a marginally additional length to accommodate the fastener so self-adjusting.

Overall, the optimal wood-to-wood contact area of the instrument of present art is completely lost on the side walls, marginally lost on the back walls, and, without any empirical evidence but based on the structural advantage of the present art, suffers no loss, or possibly gained certain extra on the bottom surface to compensate such losses on the other surfaces, compared to the wood-to-wood contact area of the conventional bolt-on guitars and other stringed instruments. The comparison results greatly vary depending on how precisely the conventional bolt-on guitars are built or adjusted in terms of the neck pocket and the counterfacing bottom segment of the neck.

The modular guitar or another instrument of present art further comprises a tremolo module solution that is attached to the body module by the string tension pulling the tremolo system upwardly into the rectangular cutout of the bottom of the body module to a bridge, and along the downward extension of the break angle of the strings at the bridge.

The tremolo module comprises a tremolo system that in turn comprises a saddle in the shape of a rectangular window, a plurality of machine tuners for guitars, a lever, a plurality of compression springs, and a whammy bar, of which the machine tuners and the whammy bar are replaceable with generally available replacement parts for conventional non-modular electric guitars, and of which the saddle and the lever are designed to accommodate the generic machine tuners and a whammy bar.

The compression springs are employed for more facilitated assembling and disassembling of the instrument to configure the counterbalancing springs to be removably attachable as a part of the tremolo module in a facilitated manner, wherein the compression springs are unloaded as a complete set when the string tension is removed, and do not require any such anchoring apparatus as found in the conventional tremolo systems that calls for intensive labor and additional tools.

The compression springs are installed in a transverse array under the top plate member of the lever, backwardly pushing against a transverse spring base plane disposed below the bridge in the proximity of and in parallel with the back side surface of the body module.

The machine tuners are disposed in two arrays facing each other on the front and back lengthwise segments of the frame of the window, in such a way that the string holes located on the posts of the machine tuners are laterally aligned in the middle of the window so that the string holes have mostly the same distance both from the bridge and a pivotal axis defined by two knife-edges to achieve the vibrato effects comparable more or less to conventional tremolo systems.

The posts of machine tuners are extending from the chassis of the machine tuners disposed on the outer walls of the lengthwise segments and into the window in a reciprocal manner from side to side. Both arrays of machine tuners have buttons extending downwardly from the outer walls of the lengthwise segments.

The saddle configuration allows for the strings extending closely in parallel from the top to the bottom of the instrument as is the case of some of the conventional tremolo systems, provides a single area of access for tension adjustment at the bottom opening of the cutout, and lastly but not the least, enables a headless and tremolo-enabled configuration for the instrument employing a set of conventional machine tuners.

The lever is designed to configure the relative positions of the compression springs, the pivotal axis of the tremolo system, and the string holes into an L-shaped pivotally leveraging configuration to dispose the comparable pivotal functionality of the conventional tremolo systems, at the same time allowing for facilitated removal of the tremolo system from the cutout.

The strings are mostly perpendicularly extending into the saddle along the extension of the break angle at the bridge, so that the saddle is held diagonally in the middle of the cutout between the front and back surfaces of the body module. The lever has two knife-edge tabs at the back bottom, laterally extending outwardly in parallel with the strings, and therefore perpendicularly to the upper surface of the saddle. The knife-edges are disposed into a couple of knife-edge mount notches that are disposed in parallel with the installed strings, on the saddle mount planes of the cutout, and oriented towards the knife-edges, and anchor the tremolo module against the string tension pulling the tremolo module towards the bridge, as the compression springs are pressed down to counterweigh at the opposite tip of the lever.

In the aforementioned L-shaped configuration, the saddle represents the bottom lateral segment of the letter “L” with the strings pulling the segment upwardly in the middle of the segment, and the compression springs are installed on the left side of the top tip of the longitudinal segment pressed into left thereof, and the knife-edges are supported by the supporting structure at the inside corner thereof.

When the string tension is removed, the set of compression springs is completely unloaded and therefore the tremolo module including the compression springs can be effortlessly removed, allowing for cleaner removal of the tremolo module compared to a typical conventional tremolo system wherein a plurality of tension springs may remain loaded, residually or otherwise, after string tension removal, and wherein the system calls for working on both front and back sides of the body using a plurality of tools as the conventional tremolo system is not designed for removable attachment.

The tremolo system of the present art is operated, pivotally functions and delivers the effects in the same manner as conventional synchronized tremolo systems, and further self-serves to remove the string tension for the removal of itself by its originally intended functionality to pivotally reduce, resume, or otherwise control the string tension by manually applied leveraging force, which also leverages and expedites the disassembling and re-assembling steps as the instrument of present art has both neck and tremolo modules relying on the string tension to maintain the integrity of the assembled configuration of the instrument.

The self-serving functionality to remove itself of the tremolo module is further facilitated on the other end of the strings disposed with a neck-end lever structure that is another actively leveraging functionality. As intended, the tremolo module solution comprises the set of strings and a part of neck-end lever structure apparatus to be removed as part of the tremolo module from the assembled instrument.

The neck-end lever structure includes a string retaining apparatus (SRA) holding the set of strings at the uppermost ends of the strings, and a string anchoring apparatus (SAA) at the uppermost end of the neck module and accepts the string retaining apparatus to anchor the strings at a set position.

In the exemplary embodiment, both SAA fixed on the neck module and SRA as a part of the tremolo module removably attached on the rear surface of SAA are a plate longitudinally disposed at the back of the uppermost segment of the neck module of an assembled instrument for the purpose of attaching one end of the strings with ball ends at the top end of the neck module in an actively leveraged manner.

SAA defines the top end of the neck module with its uppermost lateral edge, or a pivotal edge, and comprises a series of longitudinal string slots for the corresponding number of strings at its pivotal edge. The bottom edge of SAA extends across and is affixed on the crown of the neck module. A string slot is an open-ended slots extending upward to its open end at the pivotal edge. Each slot allows for the strings to enter and move along the slot, but does not allow the ball end to pass through the slot, thereby anchoring the strings at its ball end on the back surface thereof. As the strings are pulled diagonally down towards the string nut on the front side of the instrument, the ball end is anchored at the bottom of the slot on the back of SAA.

While SAA is capable of individually holding the strings without SRA, SRA actively facilitates the removable attachment by disposing a leveraging functionality to SAA. SRA comprises a lateral array of string apertures disposed along its uppermost lateral edge, or a lever edge, to hold all the strings on one plate at the ball ends thereof, as well as a lever tab, or downwardly prolonged plate area with a downwardly curved bottom edge. Said ball ends are lodged on the back side of SRA at the string apertures. The positions of string apertures are closely aligned with the positions of the string slots of SAA. The strings pass through the string apertures from the back side of the SAA before passing through the string slots of SAA to the front of the neck module and seating on the string grooves on the nut of the assembled guitar or another string instrument, so that SRA is clamped between the ball ends and SAA, and pressed down on the surface of SAA by the string tension pulling SRA towards the front.

On the exemplary embodiment of the instrument as assembled, the lever edge is positioned slightly above the pivotal edge that is slightly above the array of ball ends arrested on the array of string apertures. From top down, the lever edge, the pivotal edge, and the array of ball ends are laterally disposed and in parallel with one another and reasonably close to each other.

Said lever tab of the SRA allows for a manual operation to radially pry up the SRA from SAA at the bottom end of SRA from its pressed-down position of the assembled instrument. As the bottom end of SRA is lifted from the pressed-down position, the lever edge rotates around the pivotal edge defining the lateral axis of such rotation, and over to the front side of the SAA while the array of ball ends at the back of SRA are also lifted up and rotates together with SRA as the relational positions of the pivotal edge, the array of ball ends, and the lever tab represents a class-two lever configuration where the pivotal edge representing the pivotal axis of the fulcrum, the array of ball ends representing the load or resistance, and lever tab representing the effort points of the lever configuration. As the ball ends lift up from their completely installed positions, the string tension slightly increases.

The lever tab is downwardly prolonged enough to leverage the manually applied force to overcome any such increased tension, so that the array of ball ends continue to rotate around the pivotal edge over to the front of the SAA, thereafter the string tension decreases, and all the strings are detached from the neck module with the SRA.

When re-attaching the strings with the SRA to the SAA, the lever tab is radially pressed down to the SAA around the axis in the same actively leveraged manner as aforementioned to overcome the increased string tension when the ball ends are rotating over from the front to the back to snap SRA on to SAA.

The overall steps to assemble or re-assemble the instrument comprise a preceding step to remove part of the string tension by pressing and holding the whammy bar into the front body module surface or otherwise to bring the saddle closer to the bridge in order to further facilitate the subsequent step to manually operating the lever tab accordingly to overcome the pre-reduced string tension thereby.

The overall steps to assemble or re-assemble the instrument may also comprise a step to initially remove additional tension by rotating the machine tuners accordingly before proceeding to the steps as aforementioned, wherein such two leveraging functionalities at the opposing ends of the strings also synergistically make the overall steps effortless while further saving the risk of damage associated with excessive force being applied to the guitar or other instrument when assembling or disassembling.

### BRIEF DESCRIPTION OF THE DRAWINGS

FIG. 1 is a front perspective view of an exemplary embodiment of the present art in full configuration.

FIG. 2 is a front perspective view of a body module of the exemplary embodiment of the present art.

FIG. 3 is a front perspective view of a tremolo module of the exemplary embodiment of the present art.

FIG. 4 is a front perspective view of a neck module of the exemplary embodiment of the present art.

FIG. 5 is a schematic illustration of a transverse clamping structure of the exemplary embodiment of the present art as assembled.

FIG. 6 is a front perspective view around a cavity with the exploded body module and neck module, comprising the transverse clamping structure and an axial coupling structure.

FIG. 7 is a back perspective view around a central recessed plane with the exploded body module and neck module, comprising the axial coupling structure and an axial fastening structure.

FIG. 8 is a schematic illustration around the axial coupling structure and the axial fastening structure of the body module and neck module as assembled.

FIG. 9 is a back perspective view around the axial coupling structure and the axial fastening structure of the body module and neck module as assembled.

FIG. 10 is an exploded front perspective view around a tremolo system with a set of strings removed and a cutout of the exemplary embodiment of the present art.

FIG. 11 is a bottom view of a saddle and machine tuners of a tremolo system of the exemplary embodiment of the present art with a set of strings removed.

FIG. 12 is a back view of the tremolo system of the exemplary embodiment of the present art with a set of strings removed.

FIG. 13 is a side plan view around the tremolo system of the exemplary embodiment of the present art as assembled in full configuration.

FIG. 14 is a front perspective view around a hardtail of the exemplary embodiment of the present art as assembled in hardtail configuration.

FIG. 15 is a front perspective view around a neck-end lever structure of the exemplary embodiment of the present art.

FIG. 16 is a rear perspective view around the neck-end lever structure of the exemplary embodiment of the present art.

FIG. 17 is a side plan view around the neck-end lever structure of the exemplary embodiment of the present art.

FIG. 18 is a front perspective view of a string retaining apparatus with a set of strings of the exemplary embodiment of the present art.

FIG. 19 is a bottom perspective view of the saddle as disassembled and isolated of the exemplary embodiment of the present art.

### DETAILED DESCRIPTION OF THE INVENTION

To achieve the objectives of the present invention, the disclosure thereof is provided with an exemplary embodiment in the following detailed description with reference to the figures, given the premise that it is to be understood by those skilled in the art that the disclosure includes any possible alternative, modification, or equivalent within the spirit and scope of the invention as defined by the appended claims and claims equivalents as supported herewith.

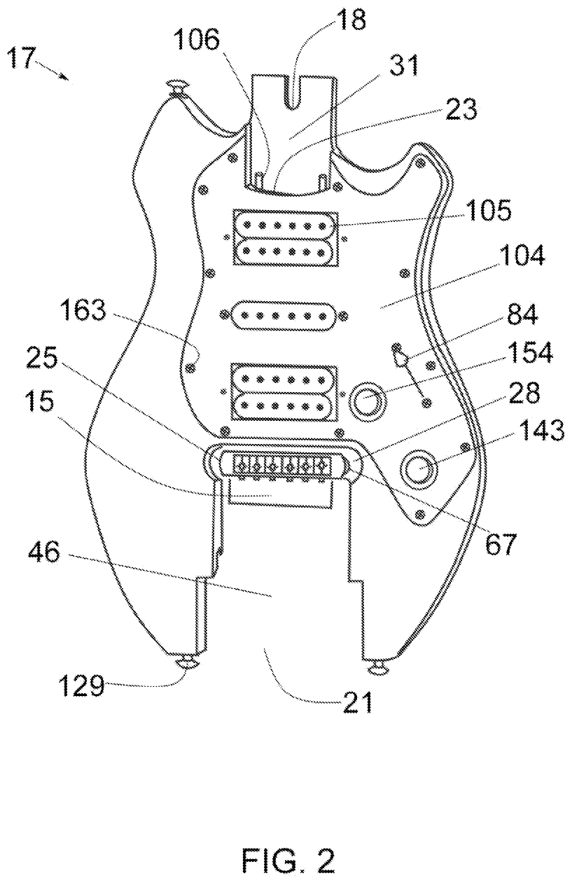

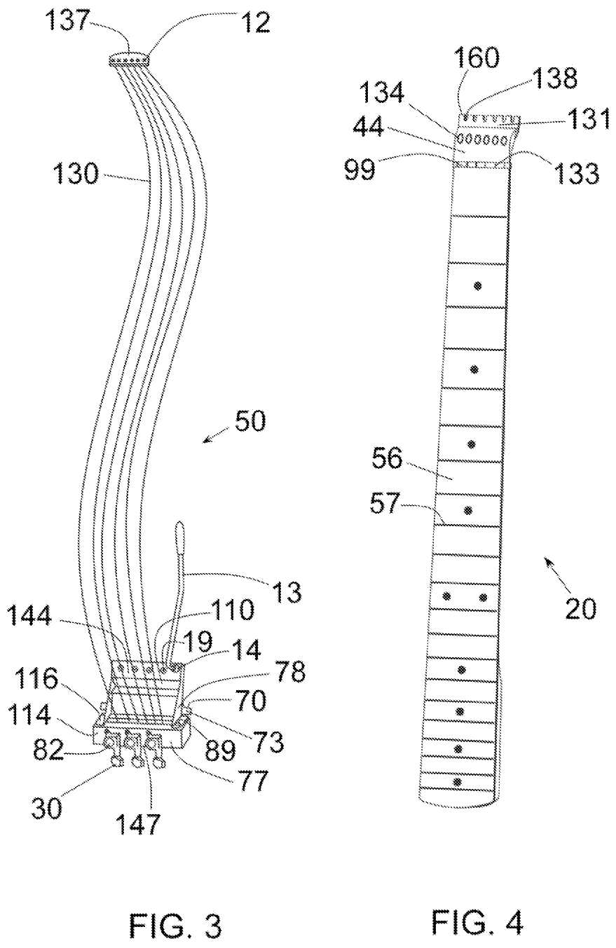

In the exemplary embodiment of the present art, the instrument is an electric guitar 1 comprising a body module 17 (FIG. 2), a neck module 20 (FIG. 4), and a tremolo module 50 (FIG. 3) detachably assembled into a complete and operational instrument following one or a plurality of expedited assembling or reassembling steps, to be re-attachably disassembled into the body module 17, the neck module 20 and the tremolo module 50 following one or a plurality of equally expedited disassembling steps.

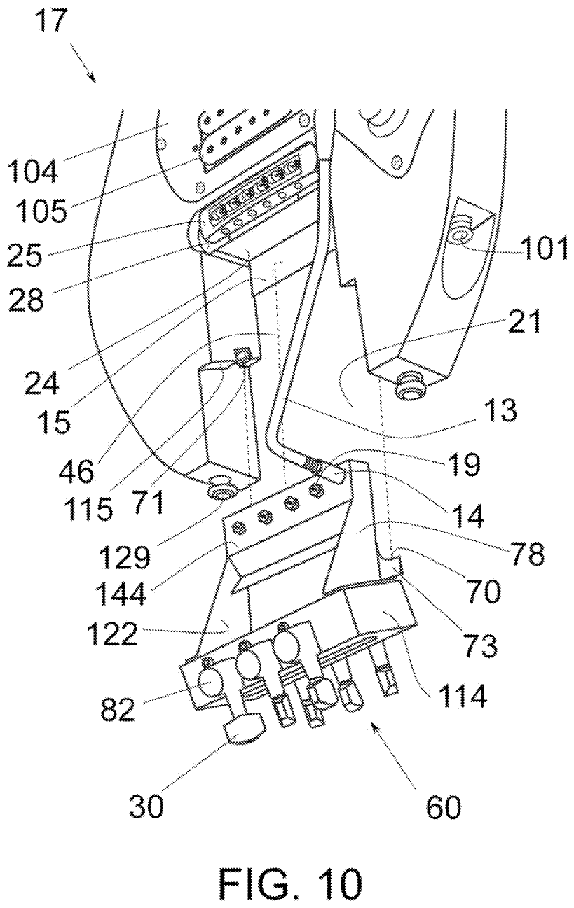

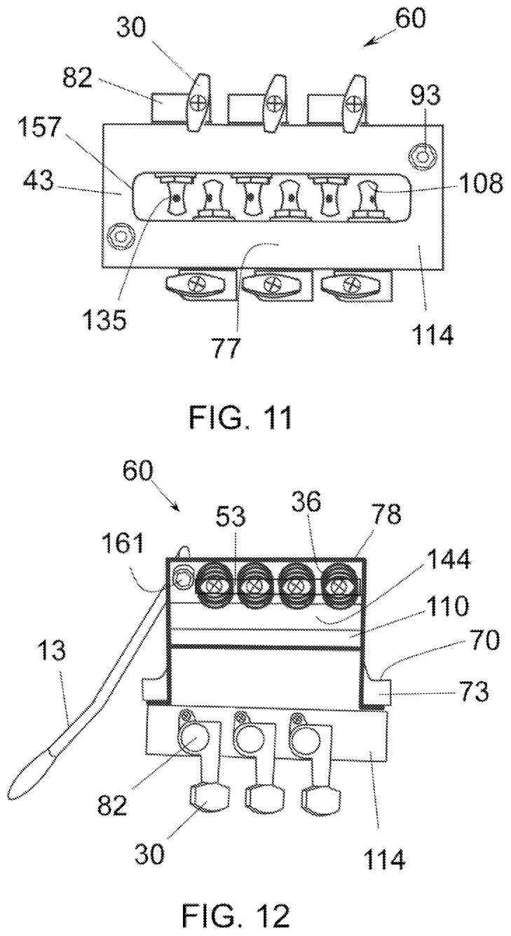

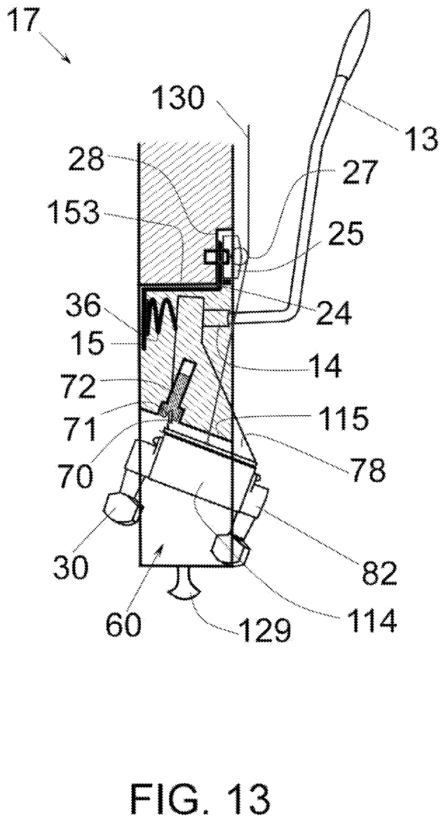

The body module 17 comprises a cavity 31 at the uppermost medial part of the front side of the body module 17 for removably securing the neck module 20 at a defined position, and a longitudinal rectangular cutout 46 through the front and back sides of the body module 17 at the center of the lowest end thereof for pivotally and removably securing the tremolo system 60 (FIG. 10). The body module 17 further comprises a bridge 25, a bridge recess 28, an electronic circuit (not shown), a pickguard 104, and three strap pins 129.

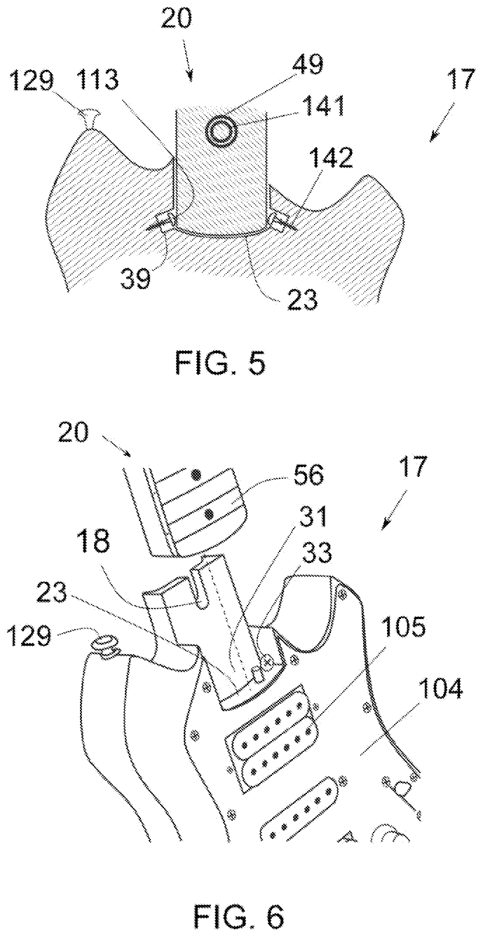

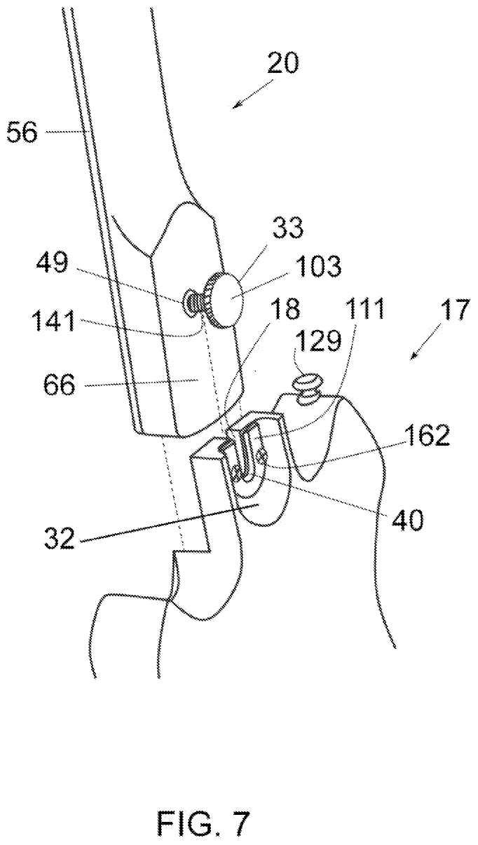

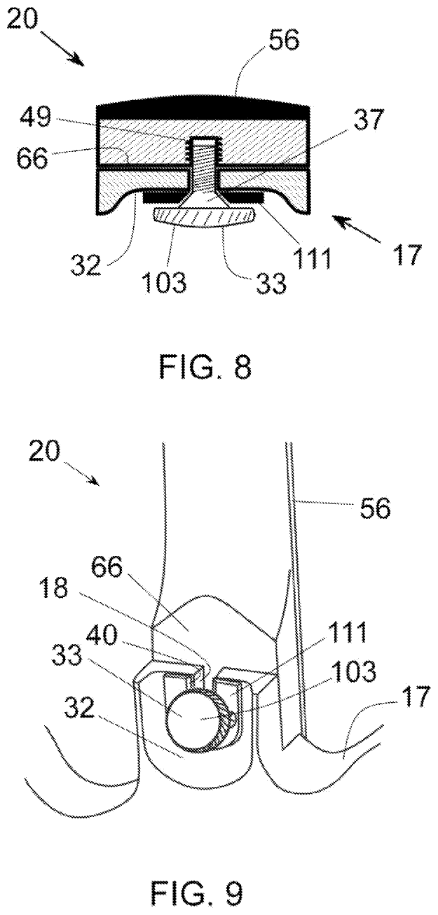

The cavity 31 comprises one or a plurality of neck pins 106, a transverse clamping structure (FIG. 5), and an axial coupling structure (FIGS. 6, 7, 8, and 9). The transverse length of the cavity 31 is minimally oversized to completely eradicate the friction between the side walls of the cavity 31 and the side walls of the neck module 20 upon inserting the neck module 20.

The cylindrical neck pin 106 is longitudinally disposed into a hole (not shown) on the bottom surface of the cavity 31, and half of each neck pin 106 protrudes from the hole (not shown) and fits into a coupling hole (not shown) on the bottom tip of the neck module 20 in order to provide support during the steps to removably attach the tremolo module 50 to the assembled neck module 20 and body module 17 placed in a recumbent position, and to reinforce the bond between the neck module 20 and the body module 17 of the assembled instrument. The coupling hole of the neck module 20 is reasonably oversized to allow for the calibration range of the position of the neck module 20.

A transverse clamping structure (FIG. 5) of the exemplary embodiment comprises two roundhead clamp screws 142 disposed into a couple of counterbores 39 at two deepest corners of the cavity 31 to secure the bottom end segment of the neck module 20 without any play into a laterally fixed position as calibrated by rotating the two clamp screws 142.

The counterbores 39 respectively comprise screw holes (not shown) coaxially aligned with the counterbores 39, and are arranged in such a way that the clamp screws 142 are diagonally situated in the cavity 31 so that the smooth spherical surface of a roundhead 113 of the roundhead clamp screws 142 clamps the sides of the neck module 20 with sufficient friction at a precise transverse position as calibrated with the clamp screws 142. The counterbores 39 are disposed in such a way the counterbores 39 sufficiently allow for the roundheads 113 of the clamp screws 142 to be adjusted flush with the corresponding side walls.

Another embodiment may comprise a structure to reinforce the regional parts of both sides of the neck module 20 in contact with the clamp screws 142 for the added prevention against wear on the wood surface due to the friction against the roundhead 113 of the clamp screws 142, including without limitation a square metal plate attached flush with the side surface of the neck module 20 to cover the area in contact with the head of the clamp screw 142.

The clamp screws 142 of the exemplary embodiment are strategically positioned to facilitate the streamlined assembling of the disassembled neck module 20 and the body module 17. The oversized lateral clearance of the cavity 31 allows for the neck module 20 with the thumb screw 33 to be longitudinally slid down inside of the cavity 31 from the top without friction otherwise caused by the side walls of the oversized cavity 31, except for the lowest or last marginal segment of the cavity 31 where the neck module 20 finally experiences the friction against the roundheads 113 of the clamp screws 142 as the roundheads 113 of the clamp screws 142 respectively protrudes from the side surfaces of the cavity 31 to sufficiently limit the clearance between the side walls to allow for the fully inserted neck module 20 to be removably set at a calibrated position without play.

In the course of the disassembling of the assembled neck module 20 and body module 17, the neck module 20 experiences additional friction by the clamp screws 142 for the lowest or first marginal segment when longitudinally pulling out neck module 20 upwardly, followed by the remaining segment without friction otherwise caused by the side walls of the oversized cavity 31.

The amount of friction applied to the side walls of the neck module 20 by the roundheads 113 of the clamp screws 142, and therefore the clearance between the clamp screws 142 are calibrated by adjusting or readjusting the diagonally transverse positions of the clamp screws 142. Likewise, the lateral position of the clearance between the clamp screws 142 within the cavity 31 is calibrated in the same manner. The positions of the clamp screws 142 are adjusted by rotating the clamp screws 142 clockwise or counter-clockwise as the case may be to dispose further into or out of the respective screw holes (not shown).

For example, the position of one side wall surface of the neck module 20 can be adjusted by removing the neck module 20 from the cavity 31 and rotating the relevant clamp screw 142 in contact with the side wall of the neck module 20 clockwise to dispose the roundhead 113 further into the counterbore 39, and therefore reducing the portion of the roundhead 113 protruding from the side wall surface to adjust or readjust the neck module 20 side wall closer to the side wall of the cavity 31, or by rotating the clamp screw 142 counter-clockwise to dispose the roundhead 113 further out of the counterbore 39, and therefore increasing the portion of the roundhead 113 protruding from the side wall surface to adjust or readjust the neck module 20 side wall further away from the side wall of the cavity 31. Thereafter the other clamp screw 142 is accordingly rotated clockwise or counter-clockwise as the case may be to dispose the roundhead 113 further into or out of the counterbore 39, and therefore decreasing or increasing the portion of the roundhead 113 protruding from the side wall surface of the cavity 31 to apply sufficient friction to the both of the side walls of the neck module 20 to set at a calibrated position in the cavity 31, allowing for no play inside the cavity 31.

The axial coupling structure (FIGS. 6, 7, 8, and 9) of the exemplary embodiment comprises a central recessed plane 32, a bolt slot 18, and a U-shaped reinforcement plate 111. The axial coupling structure (FIGS. 6, 7, 8, and 9) accepts the axial fastener structure (FIGS. 6, 7, 8, and 9) of the neck module 20 to removably secure the neck module 20 at the calibrated position together with the calibrated transverse clamping structure (FIG. 5), wherein the axial coupling structure (FIGS. 6, 7, 8, and 9) sets a longitudinally adjustable lateral position with a sagittal or front-to-back axis of the thumb screw 33 of the axial fastener structure (FIGS. 6, 7, 8, and 9). The axial coupling structure (FIGS. 6, 7, 8, and 9) further ensures optimal wood-to-wood contact across the back wall of the cavity 31.

Central recessed plane 32 in the uppermost medial part of the back side of the body module 17 provides a countersink 40 for the thumb screw 33 when the neck module 20 is assembled on the body module 17. The countersink 40 is radially oversized to permit manual operation of the thumb screw 33, and has a plane surface at the bottom of the recess that extends to the uppermost middle edge of the body module 17 to permit entry of the oversized head 103 and conical shank 37 of the thumb screw 33 at its free-hanging position (as later defined) into the plane surface, when the neck module 20 is inserted in the longitudinal direction from the uppermost side of the body module 17.

The bolt slot 18 is an open-ended longitudinal slot disposed at the center of the upper most edge of the cavity 31, and extending downwardly to the central part of the central recessed plane 32. The bolt slot 18 accepts the threaded shaft 141 of the thumb screw 33 at its free-hanging position (as later defined) to be longitudinally inserted into the designated position frictionlessly, and guides the neck module 20 to the proximity of the defined position. The guiding functionality, together with the maximally reduced friction upon inserting the neck module 20 down into the oversized cavity 31, aids in preventing any possible damage to the neck module 20 or the cavity 31 due to the neck module 20 being overly misaligned from the defined position or the excessive force to be otherwise exercised to insert the neck module 20 into the cavity 31.

The back edge of the bolt slot 18 is lined with a U-shaped reinforcement plate 111 secured in the central recessed plane 32 with a plurality of wood screws 162. The reinforcement plate 111 overlays the central part of the central recessed plane 32 extending to the outermost edge of the body module 17. The reinforcement plate 111 provides a countersink 40 alongside the bolt slot 18 whereon the conical shank 37 of the thumb screw 33 is inserted and secured in a position defined as self-adjusted by the string tension for optimal wood-to-wood contact on the bottom surface of the cavity 31. The bolt slot 18 and the reinforcement plate 111 have a marginally extra segment to accommodate any such self-adjusted position of the thumb screw 33. The reinforcement plate 111 distributes the force from the conical shank 37 of the thumb screw 33 more evenly to the part overlaid by the reinforcement plate 111, and furthermore evenly to the opposite side of the cavity 31 to maximize the rigid wood-to-wood contact across the counterfacing surfaces of the neck module 20 and the body module 17 on the opposite side of the cavity 31.

The position of the neck module 20 on the body module 17 is precisely calibrated by laterally repositioning the clearance between the clamp screws 142 and therefore readjusting the radial position of the removably attached neck module 20 around the fixed sagittal or front-to-back axis defined by the thumb screw 33. The results of such calibration can be verified with the positions of the two outermost strings 130 against the fretboard 56 on the assembled instrument.

Two points of the neck module 20 supported by the transverse clamping structure (FIG. 5) at the deepest edge of the cavity 31 provides the base edge of the maximally large triangular formation, with the supported points representing its vertices, inside the cavity 31 together with the point supported by the thumb screw 33 at the uppermost part of the neck pocket, representing the uppermost vertex of the triangular formation. The triangular formation maximally reduces the leveraged force at the bottom end of the neck module 20 resulting from the excessive force applied accidentally or otherwise on the upper segment of the neck module 20 of the assembled instrument with the thumb screw 33 being the axial support point, and the clamp screws 142 representing two possibly farthermost points within the cavity 31 from the axial support.

In the exemplary embodiment, the instrument comprises a pickguard 104 that is a sheet of plastic resin overlaying a defined part of the front surface of the body module 17 to protect the surface, and to provide a mounting and enclosing means for the majority part of electronic circuit components (partly not shown). The pickguard 104 is attached to the body module 17 with a plurality of wood screws 163 strategically placed alongside the perimeter of the pickguard 104.

The electronic circuit of the exemplary embodiment comprises three pickup microphones 105, a volume control 154, a tone control 143, and a microphone selector switch 84, a plurality of lead wire strips (not shown) establishing electrically conductive connections of such components attached to the respective cutouts on the pickguard 104, and fitted inside an enclosed recess (not shown) on the front side of the body module 17 between the cavity 31 and the bridge recess 28 and covered by the pickguard 104, and output jack 101 fitted at a separate recess and communication channel (not shown) on the lower right side surface of the body module 17. The ground wire (not shown) extends to the bushing (not shown) of the bridge 25 via a communication channel (not shown) from the enclosed recess (not shown).

The strap pins 129 are longitudinally attached to the body module 17 with wood screws at the uppermost left side tip of the body module 17 and two lowest faces of the body module 17 at both sides of the opening of the cutout 46. The strap pins 129 accept the attachment openings or strings at the two ends of conventional guitar straps (not shown). The two lowest strap pins 129 of the exemplary embodiment further provide seating feet of the assembled instrument in case the instrument in an upright position is perpendicularly placed on a flat surface.

The bridge 25 comprises a plurality of bridge grooves 27, the mount bushings (not shown) and the height adjustment screws 67, and is attached on the deepest plane of the transverse bridge recess 28 on the front side of the body module 17 and above and adjacent to the cutout 46.

The bridge 25 together with the string nut 99 represents the critical points of the assembled instrument where the significant part of the vibration of the set of strings 130 is transferred to the body module 17 and the neck module 20, significantly contributing to the tonal characteristics of the assembled instrument, the present art enables the conventional string nut 99 and bridge 25 on a headless configuration of the modular instrument with facilitated attaching and detaching functionality of the set of strings 130 to and from the instrument, thereby enabling the conventional tonal characteristics of the conventional nut and conventional bridge.

However, the bridge 25 is preferably a roller bridge variant of the available guitar bridges for conventional electric guitar instruments with intonation adjustment capability as in the exemplary embodiment.

The cutout 46 is an open-ended rectangular cutout 46 located at the opposite end of the cavity 31 on the body module 17, extending from the bridge 25 downwardly to the bottom end opening 21 of the body module 17, and comprises a spring base plane 15, two saddle mount planes 115, and two knife-edge mounts 72. The longitudinal length of the cutout 46 is configured in such a way that there is sufficient clearance between the lowest end of the attached tremolo system 60 and the flat surface when the assembled instrument is perpendicularly placed on a flat surface in the upright position. The transverse length of the cutout 46 is configured in such a way that the tremolo module 50 and hardtail 63 (as defined hereafter) can be attached to and removed from the body module 17 through the bottom end opening 21 of the body module 17, and attached tremolo system 60 can be operated as intended without interference.

The spring base plane 15 is attached to the body module 17 with a bracket 24. The bracket 24 includes two lateral rectangular planes, of which one laterally overlays the back plane of the bridge recess 28 between the mount bushings (not shown) of the bridge 25 and attached thereto with a plurality of wood screws (not shown), and another extends from the lowest edge of the bridge recess 28 and overlays a part of the uppermost wall 153 of the cutout 46 extending towards the back of the body module 17. The spring base plane 15 is a lateral rectangular plate extending downwardly from the back edge of the bracket 24 and in parallel with the back surface plane of the body module 17, and provides a static surface to hold the variable load applied to the tremolo system 60 via the compression springs 36 pushing the spring base plane 15 backward. The position of the spring base plane 15 can be adjusted by replacing it with another spring base plane 15 that provides the desired position of the spring base plane 15, depending on the tension of the set of strings 130 being attached, or on the desired pivotally functional range of the tremolo system 60.

Another embodiment may comprise one of the alternative position adjustment mechanisms, including without limitation one or a plurality of height adjustment shims in the dimensions of the spring base plane 15, overlaying the front side surface of the spring base plane 15 and allowing for the adjustment of the position of the spring base plane 15 by the thickness or sum thereof without replacing the spring base plane 15.

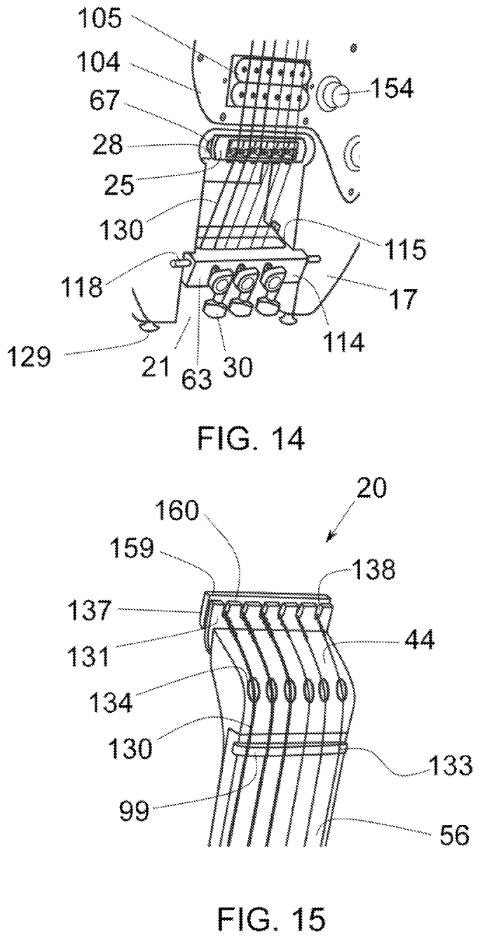

The saddle mount planes 115 of the exemplary embodiment are oblique rectangular planes facing downwardly and symmetrically disposed side to side on the side walls of the cutout 46 to provide two mounting surfaces for the saddle 114 in case of hardtail configuration (FIG. 14) (as defined hereafter). The mounting surfaces of the saddle mount planes 115 are situated in such a diagonal way that allows for the saddle 114 to be removably and stably seated therein at the proximity of its outermost edges of the top surface of the crosswise segments 43 thoroughly in contact with the respective surfaces of the saddle mount planes 115, and that the strings 130 running from the bridge 25 into the window 157 of the assembled instrument are mostly perpendicular to the top surface of the saddle 114, and further that the strings 130 are running into the window 157 in the proximity of the medial points between the front side and back side of the body module 17 in order to achieve the desired break angle of the strings 130 at the bridge 25 and therefore to adjustably configure the saddle 114 into a secured position in the proximity of the aforementioned medial point.

The saddle mount planes 115 allow for the saddle 114 to be mounted in place as the respective mounting surfaces of the saddle mount planes 115 anchor the saddle 114 against the string tension pulling the saddle 114 towards the bridge 25, and the saddle 114 is seated at the aforementioned medial point as the position achieves the possible shortest distance between the bridge grooves 27 of the bridge 25 and the string holes 135 of the machine tuners 82 across the mounting surfaces. The saddle mount planes 115 also allow for a moderate adjustment around the medial position by means of the friction between the counterfacing mounting surfaces.

Each of the saddle mount planes 115 comprises a knife-edge mount notch 71 situated symmetrically side-to-side thereon in the proximity of back side of the body module 17 to pivotally and removably accept the knife-edge tabs 73 of the tremolo module 50.

The knife-edge mount notches 71 of the exemplary embodiment comprise an integrated cylindrical mounting shaft and a cylindrical base coaxially aligned. The cylindrical base comprises a V-shaped knife-edge mount notch 71 in the center of the bottom surface of the cylindrical base wherein the knife-edge tab 73 is seated to configure a fulcrum with minimal friction for the tremolo system 60. The cylindrical mounting shaft and a cylindrical base are disposed perpendicularly to the saddle mount planes 115 in mounting cavities with a hole in the center thereof to accept the cylindrical shaft thereof.

The knife-edge mount notch 71 allows for the knife-edge tab 73 to be removably mounted in place as the knife-edge mount notch 71 anchors the knife-edge tab 73 against string tension pulling the knife-edge tab 73 towards the bridge 25, so that the knife-edge 70 is automatically detached from the knife-edge mount notch 71 when the string tension is removed, and therefore the tremolo module 50 comprising is removed without any additional step, altogether with the compression springs 36.

The neck module 20 of the exemplary embodiment comprises a fretboard 56 across the front side thereof, a plurality of frets 57 across the fretboard 56, a truss rod (not shown) in a closed channel (not shown) underneath the fretboard 56, a heel plane 66 at the lowest segment of the back of the neck module 20, and a crown 44 at the uppermost segment of the neck module 20. The neck module 20 further comprises a comb-shaped string anchoring apparatus 131 on the crown 44, a string nut 99, an axial fastener structure (FIGS. 6, 7, 8, and 9) on the heel plane 66, and a plurality of recesses of string guides 134 between the string anchoring apparatus 131 and the string nut 99.

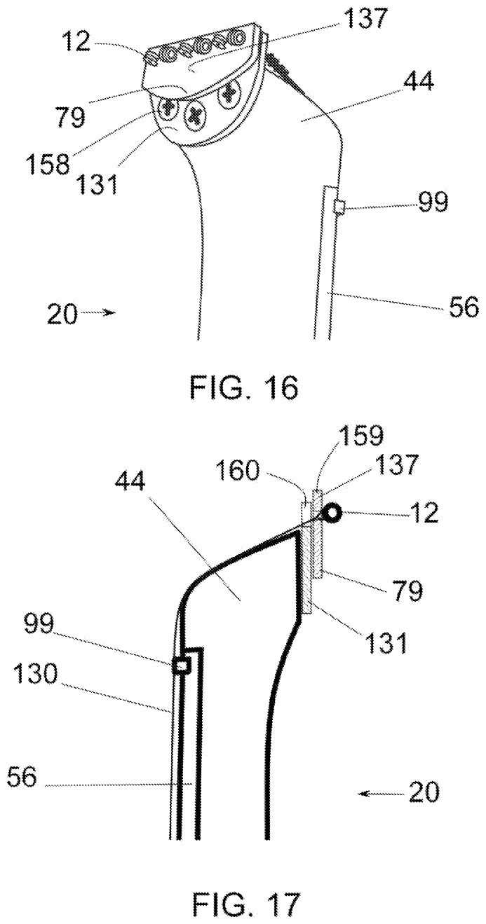

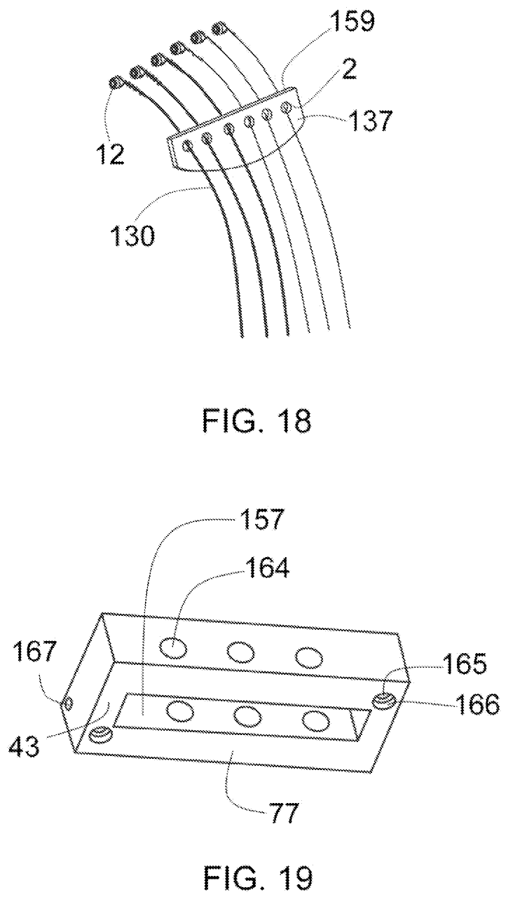

The string anchoring apparatus 131 of the exemplary embodiment is a sheet of metal in the shape of a hair comb, and constitutes the uppermost end of the neck module 20. The string anchoring apparatus 131 is secured with three wood screws 158 at the back of the crown 44. The curved bottom end aligns with the perimeter of the crown 44 of the neck module 20. The string anchoring apparatus comprises a pivotal edge 160 for a neck-end lever structure (FIGS. 15, 16, 17) at the uppermost end, and the pivotal edge 160 of the string anchoring apparatus 131 comprises a plurality of string slots 138 aligned along the lateral edge.

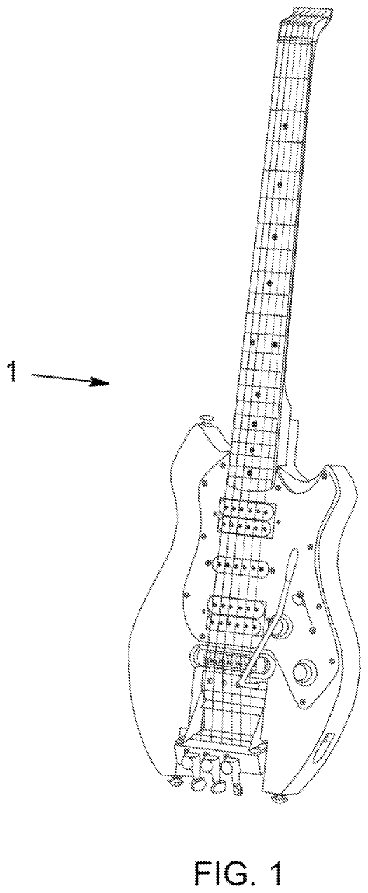

The string slots 138 are an array of longitudinal open-ended slots positioned at comparable intervals to the intervals of the set of strings 130 at the string nut 99, and are aligned with the corresponding string grooves 133 on the string nut 99. The string slots 138 are cut in a way that allows the installation of the individual string 130 with a ball end 12 by anchoring the ball end 12 to the string slot 138 without the string retaining apparatus 137. The longitudinal lengths of the string slots 138 are configured in a way that allows the lever tab 79 of the string retaining apparatus 137 to be attached and detached by overcoming the remaining tension of the strings 130 as has been pre-reduced by the machine tuners 82 in case of the hardtail configuration (FIG. 14) (as defined hereafter), or by the tremolo system 60 after optionally being pre-reduced by machine tuners 82 in case of the full configuration (FIG. 1) in the assembling and disassembling steps (as set out hereafter), and that the string retaining apparatus 137 is kept secured in position when the tremolo system 60 is operated to maximally reduce the string tension in the musical performance of the assembled instrument.

The string guides 134 are positioned between the string nut 99 and string slots 138 and aligned with the corresponding string slots 138 to set the break angle of the strings 130 at the string nut 99 as well as the angle between the string anchoring apparatus 131 and the strings 130 by holding the string 130 at a desired position.

In the exemplary embodiment, the string guides 134 are integrally configured as the longitudinal recesses on a part of the front wood surface of the crown 44.

The string nut 99 is a nut generally available for, or mounted on the neck of non-portable conventional electric guitar instruments as aforesaid. The string nut 99 comprises the corresponding number of string grooves 133 to the strings 130 to be attached to the instrument to hold the strings 130 at defined positions at the uppermost end of the fretboard 56.

The axial fastener structure (FIGS. 6, 7, 8, and 9) of the exemplary embodiment comprises a D-nut 49 and a thumb screw 33 to be engaged with the axial coupling structure (FIGS. 6, 7, 8, and 9) to removably secure the neck module 20 to the body module 17.

The D-nut 49 is a nut with wood screw threads on the outside cylindrical surface. The D-nut 49 is disposed into a mounting hole at the defined medial position between the side edges of the heel plane 66 in such a manner that the back end of the D-nut 49 is flush with the heel plane 66 of the neck module 20, or no part of the D-nut 49 is protruding from the heel plane 66. The D-nut 49 is situated in such a position that the head of the thumb screw 33 is secured at the defined position in the central recessed plane 32. The D-nut 49 preferably provides such a total surface area of helical threads contacting the wood of the neck module 20 that is comparable to such a total surface area of the threads of wood screws comprising the conventional bolt-on joint configurations.

The thumb screw 33 is a bolt with an oversized head 103 with knurled perimeter circumference allowing for sufficient fastening of the body module 17 and neck module 20 by manually rotating the oversized head 103 clockwise, and a conical shank 37. The thumb screw 33 is adjustably disposed into the D-nut 49.

The thumb screw 33 may be disposed into the D-nut 49 in two positions, comprising a fixed position wherein the thumb screw 33 is fully engaged to hold the adjustably static bond between the neck module 20 and the body module 17, and a free-hanging position wherein the thumb screw 33 is attached to the D-nut 49 but allowing for the neck module 20 to be freely inserted or pulled out of the neck module 20. Alternative embodiments may include a hexagonal hole for a generic hex key to be used in case of over-tightening of the thumb screw 33 causing difficulty in detaching the screw to disassemble the instrument. The conical shank 37 of the exemplary embodiment fits into the countersink 40 of the reinforcement plate 111 alongside the bolt slot 18, securing the neck module 20 in a self-adjusted position. The dimensions of oversized head 103 are defined in such a way that the oversized head 103 can be rotated manually to achieve sufficient fastening of the neck module 20 and body module 17, and that the oversized head 103 can be secured within the central recessed plane 32 and entirely or mostly flush with the back side surface of the body module 17 in the central recessed plane 32. The length of the threaded section of the shaft of the thumb screw 33 is defined in such a way that the neck module 20 can be longitudinally inserted without interference into the neck pocket on the body module 17 in the free-hanging position, and that the conical shank 37 of the thumb screw 33 in the fixed position can be seated on the countersink 40 of the reinforcement plate 111 to secure the neck module 20 onto the body module 17.

Another embodiment may include a thumb screw 33 the head of which comprises a clamping mechanism that may include a foldable lever into one or both of the bolt slot 18 or central recessed plane 32 to configure one or a plurality of flush surfaces with the back and other corresponding planes on the body module 17, as the case may be, whereon any such feature is defined or configured.

The tremolo module 50 of the exemplary embodiment comprises a tremolo system 60, a string retaining apparatus 137, and a plurality of strings 130. The tremolo module 50 provides the vibrato functionality comparable to a conventional synchronized tremolo system on the conventional electric guitars, and also facilitates the disassembling and reassembling steps of the instrument by providing a prompt removal and reinstallation of the entire or most of the string tension of the instrument. The string retaining apparatus 137 constitutes a neck-end lever structure (FIGS. 15, 16, 17) together with the string anchoring apparatus 131 on the neck module 20.

The tremolo system 60 comprises a lever 78, a saddle 114, a set of machine tuners 82, and a whammy bar 13 to deliver the comparable pivotally leveraging functionality to conventional synchronized tremolo systems. More specifically, the tremolo system 60 normally stays in a position wherein the string tension of the strings 130 tuned at respectively defined tonal pitches and the counterbalance applied by the compression springs 36 are in balance. The tremolo system 60 is actuated by moving the whammy bar 13 into the body or away from the body by manually applied force to the whammy bar 13 to pivotally decrease or increase the length of the segment of the strings 130 between the string nut 99 and the saddle 114, and thereby decrease or increase the string tension to modulate the tonal pitches for musical expressions including without limitation vibrato effect. The tremolo system 60 automatically resumes the balanced position after removing the manually applying force. The functionality is also utilized to facilitate the removing and reinstalling of the string tension when assembling or disassembling the instrument.

The lever 78 of the exemplary embodiment comprises a top plate member 144, L-profile reinforcement beam member 110, and two side wall members 122 symmetrically disposed side to side and connected at the lateral edges of the top plate member 144, saddle mount tabs 116 symmetrically disposed side to side, a plurality of compression springs 36, two knife-edge tabs 73 symmetrically disposed side to side, whammy bar 13, and a bar mount 14 to removably attach a whammy bar 13 to manually operate the tremolo system 60 on the front side of the top plate member 144.

The saddle mount tabs 116 at the lowest part of the lever 78 provide the planes to removably hold and secure the saddle 114 at the part of the upper surface of the crosswise segments 43 thereof with two mounting bolts 89 diagonally disposed through the saddle mounting holes on the saddle mount tabs 116.

The compression springs 36 are secured on the back plane of the top plate member 144 with a fastening strip 53 which is secured to the top plate member 144 with the same number of bolts and nuts 19 as the springs. The bolts and nuts 19 are respectively disposed at the axial centers of the springs from the front side to the back side of the top plate member 144. The compression springs 36 provide the counterbalancing force against the string tension and manually applied force of the actuated tremolo system 60. While the front end of the compression springs 36 are fastened on the top plate member 144 with a fastening strip 53, the back ends of the compression springs 36 are simply pressed down to the spring base plane 15 without any securing mean, and therefore further facilitates the removable attachment of the compression springs 36 to the instrument as part of the removable tremolo module 50, compared to such one or a plurality of tension springs of the conventional synchronized tremolo system that are installed longitudinally across the body and most often require a plurality of tools and access from both front and back sides.

The top plate member 144 is the uppermost part of the lever 78 and holds the compression springs 36. The lowest part of the top plate member 144 comprises an integrated L-profile reinforcement beam member 110 across two side wall members 122.

The knife-edge tabs 73 are square-shaped tabs with the uppermost tapered edges, inclining forwardly and extending outwardly in the opposite transverse directions from the back bottom end of the sidewalls in the proximity of the saddle mount tabs 116, and allow for the removable attachment to the knife-edge mount notches 71 attached to the saddle mount planes 115 of the body module 17, configuring the fulcrum of the tremolo system 60 together with the knife-edge mount notches 71. The uppermost tapered edges respectively have outer tapered edge segments and inner oblique edge segments towards the connected side wall members 122 to keep the clearance between the respective side wall members 122 of the lever 78 and the side walls of the cutout 46 of the assembled instrument to ensure the operation of the tremolo system 60 without interference with the side walls of the cutout 46. The longitudinal length of the knife-edge tabs 73 is configured in such a way that the planes of the saddle mount tabs 116 are mostly in parallel with the saddle mount planes 115 when the instrument is assembled in the full configuration (FIG. 1) and when the tremolo is not actuated, thereby allowing for sufficient clearance for the operation of the tremolo system 60 without any interference with the saddle mount planes 115. The transverse length of the knife-edge tab 73 is configured in such a way that both of the knife-edge tabs 73 can be inserted into the corresponding knife-edge mount notches 71 without any interference, and that the non-oblique segments of the tapered edges occupies the majority of the transverse length of the knife-edge mount notches 71. As aforementioned, the knife-edge tab 73 is anchored in the knife-edge mount notch 71 by means of the string tension pulling the tremolo system 60 towards the neck module 20 and the counterbalancing compression springs 36, and therefore is automatically removed from the knife-edge mount notch 71 after removing part of the string tension with one or both of the set of machine tuners 82 and the tremolo system 60.

The removable whammy bar 13 is a whammy bar generally available for the conventional synchronized tremolo systems, and attached to any such instrument with the threads on the mounting segment thereof. The whammy bar 13 provides the handle to manually operate the tremolo system 60 for the musical expressions or the disassembling and reassembling of the instrument as per the steps set out hereafter.

Preferably, the thickness of the round bar of the whammy bar 13 is sufficient to withstand the operational force during the disassembling and reassembling of the instrument. The exemplary embodiment comprises a generic 5 mm diameter whammy bar for the traditional synchronized tremolo systems.

The bar mount 14 is a cylindrical tube with threaded inner surfaces to accept the threaded mounting segment of the whammy bar 13 to be adjustably attached, and is perpendicularly attached onto the front side of the top plate member 144, and secured at a defined position on the plate in the proximity of the one or the other lateral edges of the top plate member 144, depending on the dominant hands of the instrumentalists, with a mounting bolt 161 disposed from the back side of the top plate member 144 into the threads of the bar mount 14. The length of the mounting bolt 161 is configured in such a way that leaves a sufficient internally threaded segment of the tube for the mounting threads of the whammy bar 13.

The saddle 114 in this exemplary embodiment is a rectangular piece of tone wood as is used for the body module 17 with a rectangular opening window 157 cut out in the center of the uppermost plane through the bottom plane thereof, framed by front and back lengthwise segments 77 in parallel and two crosswise segments 43 in parallel. The saddle 114 comprises a plurality of machine tuner mounting apertures 164 on the outermost surface of its two lengthwise segments 77 through to the window 157, a couple of mounting nuts 93, a couple of mounting channels 165, and removable saddle mounting pins 118.

The saddle 114 is removably attached to the lever 78 with a couple of mounting bolts 89 disposed through the saddle mount tabs 116 of the lever 78 and through a couple of mounting channels 165 extending at two corners of the saddle 114 into the corresponding mounting nuts 93 in the counterbores 166 on the opposite side of the saddle 114.

The saddle 114 provides a capability to accept a wider variety of conventional electric guitar machine tuners for the purpose of tension adjustment at the bottom end opening 21 of the body module 17 on the saddle 114 both in the hardtail configuration (FIG. 14) and the full configuration (FIG. 1).

The instrument may be assembled without the lever 78 removably attached to the saddle 114, with an alternatively arranged hardtail module 63 including the saddle 114, a plurality of machine tuners 82, a plurality of strings 130, string retaining apparatus 137 and a couple of saddle mounting pins 118. As aforementioned, the hardtail module 63 is attached on the saddle mount planes 115 of the body module 17 at the front surface of the crosswise segments 43 of the saddle 114 for the hardtail configuration (FIG. 14) of the instrument.

In the hardtail configuration (FIG. 14) of the exemplary embodiment, a couple of saddle mounting pins 118 protrude outwardly and symmetrically side to side from the respective pin mounting holes 167 on two lateral side surfaces of the saddle 114 in the opposite transverse directions alongside the front plane of the body module 17 of the assembled instrument in the hardtail configuration (FIG. 14). The saddle mounting pins 118 are removably disposed into the respective mounting holes 167 to provide support to temporarily hold the saddle 114 in position when disassembling and reassembling the instrument, by suspending the saddle 114 from the front surface of the recumbently placed guitar into the cutout 46 thereof.

The machine tuner 82 is an independent machine tuner 82 generally available for the conventional electric guitar instruments including without limitation so-called in-line and three-per-side arrangements of machine tuner set on the headstock of any such instrument. The posts 108 of the set of machine tuners 82 must share an equal longitudinal length that allows the strings 130 to be held at the medial point between the front and back lengthwise frame of the window 157, must be mountable on the saddle 114 free of any interference, and must be mountable into the mounting apertures (not shown) with or without shims as may be required.

Preferably, the machine tuners 82 are procured as a set for the in-line arrangement of conventional electric guitar instruments, and respectively have a couple of transverse string holes 135 for the strings 130, and do not comprise a coaxial screw string clamping mechanism. Notwithstanding the foregoing, any such guitar machine tuner that meets the aforementioned required details can be used or can replace for rescue in case of emerging failure or repair.

The machine tuners 82 and their respective mounting apertures 164 are aligned and arranged on two lengthwise segments 77 of the saddle 114 in such a way that the machine tuners 82 are mounted alternating between the two lengthwise segments 77 of the saddle 114 from one crosswise segment 43 to the other crosswise segment 43 of the frame of the window 157, and that the posts 108 of the machine tuners 82 protruding reciprocally from the lengthwise segments 77 of the saddle 114 into the window 157 are equally distanced from each other, and further that all of the buttons 30 of the set of machine tuners 82 are oriented downwards. For example, in the exemplary embodiment with a set of six machine tuners 82 from one crosswise segment 43 to another crosswise segment 43, the posts 108 of the first, third, and fifth machine tuners 82 extend from one array on the front segment, and the posts 108 of the second, fourth, and sixth machine tuners 82 extend from another array on the back segment into the window 157, with all of the buttons 30 of the set of machine tuners 82 oriented downwards.

Furthermore, the machine tuners 82 and their mounting apertures 164 are arranged in relation to their attached strings 130 in such a way that each of the attached strings 130 is held straight across the segment of the string 130 between the string nut 99 and the saddle 114 except for the break angle into a direction shared across the strings 130 at the bridge 25, and that the attached strings 130 extend mostly perpendicularly into the window 157 at the medial points between the two lengthwise segments 77 of the saddle 114 when the tremolo system 60 is not actuated, or when the saddle 114 is removably attached without the lever 78.

In the exemplary embodiment, the string retaining apparatus 137 is a piece of rectangular-shaped sheet metal, and comprises a bottom round curved edge in its assembled position, and a plurality of string apertures 2 for the corresponding number of strings 130. The round curved edge is configured to be a lever tab 79. The string retaining apparatus 137 is held in position on the string anchoring apparatus 131 by the tension of the strings 130 pulling the string retaining apparatus 137 into the locking position. The width of the string retaining apparatus 137 corresponds to the width of the string anchoring apparatus 131 on the neck module 20. The longitudinal measurement of the string retaining apparatus 137 is less than the longitudinal measurement of the string anchoring apparatus 131.

The string apertures 2 are arranged as an array of holes in the proximity of and in parallel with the transverse lateral edge of the string retaining apparatus 137. The intervals between the string apertures 2 correspond to the intervals between the string slots 138 on the string anchoring apparatus 131 so that each string aperture 2 and corresponding string slot 138 closely align when the string retaining apparatus 137 with the strings 130 attached to the string anchoring apparatus 131. The diameters of the string apertures 2 are configured in such a way that the aperture permits the corresponding string 130 in use to be inserted up to the ball end 12, and that each string aperture 2 does not permit the ball end 12 to pass through, whereby the string retaining apparatus 137 is trapped between the ball ends 12 of the strings 130 and the machine tuners 82 of the disassembled tremolo module 50, and the ball ends 12 are anchored at the back of the string retaining apparatus 137 of the assembled instrument.

The lever tab 79 facilitates the removable attachment of the string retaining apparatus 137 to the string anchoring apparatus 131 by radially leveraging the force manually applied to the lever tab 79 to overcome the remaining string tension after being decreased by turning the machine tuners 82 clockwise or counter-clockwise as the case may be, or pressing down the whammy bar 13, or both in the steps set out hereafter.

The uppermost lateral edge of the string retaining apparatus 137 constitutes a lever edge 159 that slightly extends over the pivotal edge 160 of the string anchoring apparatus 131 in order to arrange a class-two lever configuration of the neck-end lever structure (FIGS. 15, 16, 17) wherein the pivotal edge 160 of the string anchoring apparatus 131 functions as the pivotal fulcrum whereon the string retaining apparatus functions as a lever and radially pivots to leverage the manually applied force to the lever tab 79 to overcome any such remaining string tension as later described hereafter to rotate the array of anchored ball ends 12 at the back of the string retaining apparatus 137 over to the front side of the string anchoring apparatus 131, and therefore to remove the strings 130 out of the string slots 138. Likewise, when re-attaching the strings 130 with the string retaining apparatus 137 to the string anchoring apparatus 131, the lever tab 79 is radially pressed down to the string anchoring apparatus 131 around the pivotal edge 160 in the same actively leveraged manner as aforementioned to overcome the increased string tension when the ball ends 12 are rotating from the front over to the back of the string anchoring apparatus 131 to snap the string retaining apparatus 137 on to the string anchoring apparatus 131.

The string retaining apparatus 137 of the disassembled tremolo module 50 is trapped between the ball ends 12 of the strings 130 and the machine tuners 82 to help prevent the set of strings 130 from entangling or otherwise being damaged.

The set of strings 130 may be one of the various assorted sets of strings for the conventional electric guitars. Each string 130 comprises one ball end 12 on one end, and the other end thereof is attached in the same manner as the conventional electric guitars to the post 108 of the machine tuner 82 affixed to the saddle 114, and through the corresponding string aperture 2 on the back side of the string retaining apparatus 137 whereon all the ball ends 12 of the strings 130 are anchored when the instrument is assembled.

The instrument of the present art allows for two attachment options for the strings 130 in respect of the string retaining apparatus 137 as aforementioned, including the attachment with the string retaining apparatus 137 and attachment without the string retaining apparatus 137. The capability to attach the set of string 130 directly onto the string anchoring apparatus 131 without the string retaining apparatus 137 is enabled for the purpose of emerging situations wherein the string retaining apparatus 137 is lost, damaged or otherwise unavailable in order to provide additional resiliency for any such emerging situations without excluding any other intended purpose to remove and exclude the string retaining apparatus 137. The instrument as assembled or disassembled without the string retaining apparatus 137, however, does not provide any such functionality as enabled by the string retaining apparatus 137 as discussed hereinbefore.

The instrument of the present art further allows for two configuration options including the full configuration (FIG. 1) with the tremolo module 50 and the hardtail configuration (FIG. 14) with the hardtail module 63 that is arranged by removing and excluding the lever 78 of the tremolo system 60. The hardtail configuration (FIG. 14) option, unlike the options in respect of the string retaining apparatus 137, may be proactively selected as a readily convertible option alternatively preferred by the instrumentalists. To convert the tremolo module 50 into the hardtail module 63 or to convert the hardtail module 63 to tremolo module 50, the lever 78 of the tremolo module 50 may be detached or re-attached by removing or reinstalling the mounting bolts 89 of the saddle 114 respectively. However, as is the case of the string retaining apparatus 137, the functionality enabled by the tremolo module 50 is removed together with the lever 78 in case of the hardtail configuration (FIG. 14).

For both full configuration (FIG. 1) and hardtail configuration (FIG. 14), the neck module 20 is removably secured in position to the body module 17 with a thumb screw 33 extending from the back side of the body module 17 and through the bolt slot 18 and the reinforcement plate 111 at the end of the cavity 31 into the D-nut 49 of the neck module 20, and with the roundheads 113 of the clamp screws 142 of the transverse clamping structure (FIG. 5) disposed into the mounting holes at two deepest corners of the cavity 31.

For the full configuration (FIG. 1), the tremolo module 50 comprising a lever 78, a saddle 114, a string retaining apparatus 137 and a plurality of strings 130, is removably attached to the body module 17 inside the cutout 46 with its knife-edge tabs 73 removably seated in the knife-edge mount notches 71 to configure a fulcrum that allows for addition and reduction of the string tension by pivotally operating the whammy bar 13, and with the compression springs 36 pressing down on the spring base plane 15 to add the leveraged counterbalance against the string tension via the lever 78 and the configured fulcrum as aforementioned. The tremolo system 60 is kept in the pivotally operational position with the string tension upwardly pulling the tremolo system 60 towards the neck module 20 and the counterbalance applied by the compression springs 36. The ball ends 12 of the strings 130 are anchored on the string apertures 2 at the back side of the string retaining apparatus 137 being attached on the string anchoring apparatus 131 at the crown 44 of the neck module 20 and is kept in place by the string tension pulling the strings 130 towards the body module 17 and therefore the strings 130 are pulled into the lowest ends of the string slots 138, thereby pulling the string retaining apparatus 137 into the string anchoring apparatus 131 at a stable position. As is also the case of the conventional electric guitar instruments, the string tension allows for the strings 130 to be securely seated in the corresponding string grooves 133 of the string nut 99 and on the corresponding bridge grooves 27 of the bridge 25.

For the hardtail configuration (FIG. 14), the hardtail module 63, comprising a saddle 114, a string retaining apparatus 137 and a plurality of strings 130 excluding the lever 78 as well as compression springs 36 and the whammy bar 13, is removably attached to the body module 17 inside the cutout 46 with its two crosswise segments 43 of the saddle 114 removably seated on the corresponding saddle mount planes 115 with the counterfacing surfaces optimally in contact with one another. The saddle 114 is kept in the aforementioned transverse position with the saddle 114 anchored by the saddle mount planes 115 as the string tension is pulling the saddle 114 upwardly towards the bridge 25. The strings 130 and the string retaining apparatus 137 are configured to function on the string anchoring apparatus 131 in the same manner as in the full configuration (FIG. 1).

For the full configuration (FIG. 1), the steps to detach the tremolo module 50 from the assembled instrument comprise:
An optional step to preliminarily remove such part of the string tension as may be required by rotating the buttons 30 of the machine tuners 82 clockwise or counter-clockwise as the case may be;
A step to press and hold the whammy bar 13 of the tremolo system 60 into the central part of the body module 17 to further remove an additional part of the string tension enough to operate the lever tab 79 of the string retaining apparatus 137;
A step to operate the lever tab 79 manually by radially turning the lever tab 79 around the pivotal edge 160 of the string anchoring apparatus 131 to overcome the remaining string tension and pry up to detach the string retaining apparatus 137 from the string anchoring apparatus 131; and
A step to pull the tremolo module 50 out of the cutout 46 of the body module 17 to remove the tremolo system 60.

For the hardtail configuration (FIG. 14), the steps to detach the hardtail module 63 from the assembled instrument comprise:
A step to rotate the buttons 30 of the machine tuners 82 clockwise or counter-clockwise as the case may be to remove the string tension enough to operate the lever tab 79 of the string retaining apparatus 137;
A step to operate the lever tab 79 manually by radially turning the lever tab 79 around the uppermost edge of the string anchoring apparatus 131 to manually overcome the remaining string tension and pry up to detach the string retaining apparatus 137 from the string anchoring apparatus 131; and
A step to remove the hardtail module 63 from the cutout 46 of the body module 17.

For both full configuration (FIG. 1) and hardtail configuration (FIG. 14), the steps to remove the neck module 20 from the instrument with the tremolo module 50 or hardtail module 63 previously removed comprise:
A step to set the thumb screw 33 to the free-hanging position by rotating the thumb screw 33 counter-clockwise;
A step to pull up the neck module 20 in the longitudinal direction with the thumb screw 33 in the free-hanging position to unseat the neck module 20 from the clearance between the clamp screws 142 of the transverse clamping structure (FIG. 5); and
A step to further pull up the neck module 20 in the longitudinal direction out of the cavity 31.

For both full configuration (FIG. 1) and hardtail configuration (FIG. 14), the steps to attach or reattach the neck module 20 from the instrument with the tremolo module 50 or hardtail module 63 previously removed comprise:
A step to longitudinally slide down the neck module 20 with the thumb screw 33 in the free-hanging position into the cavity 31 down to the transverse clamping structure (FIG. 5) while at the same time inserting the attached thumb screw 33 into the bolt slot 18;
A step to press the neck module 20 fully down into the clearance between the clamp screws 142 of the transverse clamping structure (FIG. 5); and
A step to set the thumb screw 33 into the fixed position by rotating the thumb screw 33 clockwise.

For the full configuration (FIG. 1), the steps to attach or reattach the tremolo module 50 to the assembled body module 17 and neck module 20 comprise:
A step to insert and hold the knife-edge tabs 73 into the corresponding knife-edge mount notches 71 from the cutout 46 of the body module 17 with the compression spring 36 placed on the spring base plane 15 while keeping the detached string retaining apparatus 137 in the proximity of the string anchoring apparatus 131 across the front side of the assembled body module 17 and neck module 20;
A step to press and hold down the whammy bar 13 of the tremolo module 50 into the central part of the body module 17 to reduce the length between the string anchoring apparatus 131 and the tremolo system 60;
A step to align the string retaining apparatus 137 with the string anchoring apparatus 131 and place the strings 130 into the corresponding string slots 138 of the string anchoring apparatus 131 by pressing down the lever tab 79 of the string retaining apparatus 137 from the front side to the back side of the string anchoring apparatus 131 while manually overcoming the string tension remained from the preceding detaching steps of the tremolo module 50 while holding down the whammy bar 13; and
A step to rotate the button 30 of each machine tuner 82 clockwise or counter-clockwise as the case may be for the same number of turn or turns as the preceding tremolo module 50 detaching steps, but in the opposite directions to add the tension required for each string 130 to be approximately in tune before disengaging the whammy bar 13; and
A step to fine-tune the strings 130 by rotating the machine tuners 82 clockwise or counter-clockwise as the case may be.

For the hardtail configuration (FIG. 14), the steps to attach or reattach the hardtail module 63 to the assembled body module 17 and neck module 20 comprise:
A step to place the saddle 114 onto two saddle mount planes 115 of the recumbently placed body module 17 to allow the saddle 114 to be suspended by two saddle mounting pins 118 supported by the front surface of the body module 17;
A step to align the string retaining apparatus 137 with the string anchoring apparatus 131 and place the strings 130 into the corresponding string slots 138 of the string anchoring apparatus 131 by operating the lever tab 79 of the string retaining apparatus 137 to manually overcome the remaining string tension from the preceding detaching steps of the hardtail module 63;
A step to rotate the button 30 of each machine tuner 82 clockwise or counter-clockwise as the case may be for the same number of turn or turns as the preceding hardtail module 63 detaching steps, but in the opposite directions to add the tension required for each string 130 to be in tune; and
A step to fine-tune the strings 130 by rotating the machine tuners 82 clockwise or counter-clockwise as the case may be.

For the full configuration (FIG. 1) with the string retaining apparatus 137 excluded, the steps to detach the tremolo module 50 from the assembled instrument comprise:
An optional step to preliminarily remove such part of the string tension as may be required by rotating the buttons 30 of the machine tuners 82 clockwise or counter-clockwise as the case may be;
A step to press and hold the whammy bar 13 of the tremolo system 60 into the central part of the body module 17 to further remove an additional part of the string tension enough to remove the ball ends 12 of the strings 130 from the string slots 138 of the string anchoring apparatus 131;
A step to pull the tremolo module 50 out of the cutout 46 of the body module 17 to remove the tremolo system 60.

For the hardtail configuration (FIG. 14) with the string retaining apparatus 137 excluded, the steps to detach the hardtail module 63 from the assembled instrument comprise:
A step to rotate the buttons 30 of the machine tuners 82 clockwise or counter-clockwise as the case may be to remove the string tension enough to remove the ball ends 12 of the strings 130 from the string slots 138 of the string anchoring apparatus 131;
A step to remove the hardtail module 63 from the cutout 46 of the body module 17.

For both full configuration (FIG. 1) and hardtail configuration (FIG. 14) with the string retaining apparatus 137 excluded, the steps to detach the neck module 20 from the instrument with the tremolo module 50 or hardtail module 63 previously removed comprise the same set of steps as for full configuration (FIG. 1) and hardtail configuration (FIG. 14) including the string retaining apparatus 137.

For both full configuration (FIG. 1) and hardtail configuration (FIG. 14) with the string retaining apparatus 137 excluded, the steps to attach or reattach the neck module 20 to the body module 17 comprise the same set of steps as for full configuration (FIG. 1) and hardtail configuration (FIG. 14) including the string retaining apparatus 137.

For the full configuration (FIG. 1) with the string retaining apparatus 137 excluded, the steps to attach or reattach the tremolo module 50 to the assembled body module 17 and neck module 20 comprise:
A step to insert and hold the knife-edge tabs 73 into the corresponding knife-edge mount notches 71 from the cutout 46 of the body module 17 with the compression spring 36 placed on the spring base plane 15 while keeping the detached ball ends 12 of the strings 130 in the proximity of the string anchoring apparatus 131 across the front side of the assembled body module 17 and neck module 20;
A step to press and hold down the whammy bar 13 of the tremolo module 50 into the central part of the body module 17 to reduce the length of the string 130 segment between the string anchoring apparatus 131 and the tremolo system 60;
A step to place the ball ends 12 of the strings 130 to corresponding string slots 138 of the string anchoring apparatus 131; and
A step to rotate the button of each machine tuner 82 clockwise or counter-clockwise as the case may be for the same number of turn or turns as the preceding detaching steps of the tremolo module 50, but in the opposite direction to add the tension required for each string 130 to be approximately in tune before disengaging the whammy bar 13; and
A step to fine-tune the strings 130 by rotating the machine tuners 82 clockwise or counter-clockwise as the case may be.

For the hardtail configuration (FIG. 14) with the string retaining apparatus 137 excluded, the steps to attach or reattach the hardtail module 63 to the assembled body module 17 and neck module 20 comprise:
A step to place the saddle 114 onto two saddle mount planes 115 of the recumbently placed body module 17 to allow the saddle 114 to be suspended by two saddle mounting pins 118 and supported by the front surface of the body module 17;
A step to place the ball ends 12 of the strings 130 to corresponding string slots 138 of the string anchoring apparatus 131; and
A step to rotate the button 30 of each machine tuner 82 clockwise or counter-clockwise as the case may be for the same number of turn or turns as the preceding detaching steps of the hardtail module 63, but in the opposite directions to add the tension required for each string 130 to be in tune; and
A step to fine-tune the strings 130 by rotating the machine tuners 82 clockwise or counter-clockwise as the case may be.

The principles and applications of the present invention have been set out herein with reference to a particular embodiment, provided that it is to be construed that the embodiment is merely for illustrative purposes, without limiting any other version as modified or rearranged of the exemplary embodiment as may be embodied within the spirit and scope of the present invention as defined by the appended claims.

I claim:

1. A modular stringed instrument having a plurality or set of strings comprising:
a body module;
a neck module having a string anchoring apparatus; and
a tremolo module;
wherein said body module, said neck module and said tremolo module are detachably assembled into a complete and operational instrument following one or a plurality of expedited assembling or reassembling steps, to be re-attachably disassembled into said body module, said neck module and said tremolo module following one or a plurality of equally expedited disassembling steps.

2. The modular stringed instrument as in claim 1, wherein said body module having a front surface and a back surface comprising:
a longitudinal rectangular cavity at the uppermost medial part of said front surface, said cavity having a back wall, a bottom surface, and a couple of side walls;
a longitudinal rectangular cutout at the center of the lowest end of said body module, said cutout having an uppermost wall, a couple of side walls, and a bottom end opening; and
a bridge laterally disposed on said front surface of said body module above and adjacent to said cutout.

3. The modular stringed instrument as in claim 2, wherein said cavity comprising:
a transverse clamping structure along the lowest segment of said cavity; and
an axial coupling structure at the medial upper segment of said back wall of said cavity, said axial coupling structure setting a laterally fixed position against which the position of said neck module on said body module is radially calibrated by adjusting said transverse clamping structure.

4. The modular stringed instrument as in claim 3, wherein said neck module having an uppermost segment, a bottom end segment, a front side, and a back side, said neck module removably attached to said cavity of said body module, and said neck module comprising:
a fretboard longitudinally extending across said front side of said neck module;
a string nut laterally disposed at or in the proximity of the top end of said fretboard, said string nut having a plurality of longitudinal string grooves disposed at respectively defined and mostly even intervals side to side;
a crown at said uppermost segment of said neck module, said crown having said string anchoring apparatus secured thereon;
a heel plane at said back side of said bottom end segment of said neck module, said heel plane counterfacing said back wall of said cavity; and
an axial fastener structure corresponding to and closely aligned with said axial coupling structure of said cavity.

5. The modular stringed instrument as in claim 4, wherein the distance between said side walls of said cavity exceeds the lateral width of the bottom end of said neck module enough to allow for manual and effortless entry of said neck module into said cavity longitudinally from the top thereof guided by said side walls of said cavity down to said transverse clamping structure at said lowest segment of said cavity adjustably limiting said distance between said side walls of said cavity to firmly hold said bottom end of said neck module at said laterally fixed position as calibrated, together with said axial coupling structure when said bottom end of said neck module is fully inserted into said cavity by additionally manual efforts.

6. The modular stringed instrument as in claim 5, wherein said transverse clamping structure comprising a couple of clamp screws respectively having roundheads and adjustably disposed symmetrically side to side into the center of corresponding counterbores extending symmetrically side to side, outwardly and diagonally from the back bottom end of said side walls of said cavity, said clamp screws being rotated in one direction to have said roundheads protruding more out of said counterbores further limiting said distance between said side walls, or in another direction to have said roundheads less or not protruding out of said counterbores reducing the limitation to said distance, or otherwise in combination of both directions for both of said clamp screws to calibrate the position of such limited distance and therefore to calibrate the lateral position of said bottom end segment of said neck module on said body module and further to calibrate the radial position of said neck module on the body module around said laterally fixed position defined by said axial coupling structure.

7. The modular stringed instrument as in claim 5, wherein said axial coupling structure comprising:
a central recessed plane at the uppermost medial part of said back surface of said body module;
a longitudinal open-ended bolt slot at the uppermost medial part of said central recessed plane perpendicularly extending down to the central part of said central recessed plane; and
a reinforcement plate on said central recessed plane surface, said reinforcement plate lining alongside said bolt slot to provide a U-shaped countersink profile to the back edge of said bolt slot, said reinforcement plate further dispersing the fixing pressure applied by said axial coupling structure across said central recessed plane.

8. The modular stringed instrument as in claim 5, wherein said axial fastener structure of said neck module comprising:
a D-nut perpendicularly disposed in the central part of said heel plane, said D-nut laterally aligned with said bolt slot, said D-nut disposed flush with said heel plane; and
a thumb screw disposed into said D-nut having an oversized head with knurled circumference and a conical shank segment to fit in said countersink profile of said reinforcement plate at said bolt slot thereby providing a constant longitudinally and radially adjustable transverse position to removably secure said neck module to said body module together with said transverse clamping structure.

9. The modular stringed instrument as in claim 5, wherein said cavity further comprising a couple of cylindrical neck pins extending upwardly from said bottom surface and symmetrically side to side to provide reinforcement to said instrument, more critically when said instrument is recumbently disposed during said assembling and disassembling steps of said instrument.

10. The modular stringed instrument as in claim 2, wherein said cutout comprising:
a couple of transverse rectangular saddle mount planes that are symmetrical side to side facing downwardly, extending inwardly at the right angle from said side walls of said cutout, and raking backwardly;
a couple of knife-edge mount notches respectively extending perpendicularly into said saddle mount planes at the hindmost segment of said saddle mount planes symmetrically side to side, said knife-edge mount notches providing a couple of pivotal and detachable anchoring and pivotal attaching points for said tremolo module; and
a frontal rectangular spring base plane extending lengthwise and downwardly from said uppermost wall and in parallel with said back surface of said body module.

11. The modular stringed instrument as in claim 10, wherein said tremolo module is removably and pivotally attached to said knife-edge mount notches to provide a pivotal tremolo functionality to reduce, increase or otherwise control the string tension for musical expressions and for actively facilitating said assembling and disassembling of said instrument, the tremolo module comprising:
a lever providing a counterweight and a couple of removable and pivotal attachment points corresponding to said attachment points on said body module;
a saddle removably attached to said lever, said saddle in the shape of a lateral rectangular frame of an open window, said frame having front and back lengthwise segments in parallel each having an outer wall and a couple of crosswise segments in parallel respectively attached to said lever, said saddle allowing for an option to be mounted on said saddle mount planes of said cutout without said lever to assemble and operate said instrument with said pivotal tremolo functionality disabled;
a plurality of machine tuners in an arrangement, said machine tuners respectively having a plurality of posts, a plurality of string holes on said posts and a plurality of buttons, said machine tuners disposed on said front and back lengthwise segments of said saddle;
a whammy bar constituting said tremolo system of said tremolo module together with said lever defining the relative positions of effort, load, and fulcrum of said tremolo system, as well as with said saddle and said plurality of machine tuners to provide said pivotal tremolo functionality, said whammy bar removably attached to and upwardly extending from said lever alongside and over said front surface of said body module for the manually actuated, pivotal and leveraged operation of said tremolo module;
a string retaining apparatus bundling said plurality of strings, said strings respectively having ball ends anchoring on said string retaining apparatus in a lateral array at one end and respectively having the other end attached to said string holes of said posts in the central part of said cutout at the proximity of the medial plane between said front side and said back side of said body module.

12. The modular stringed instrument as in claim 11, wherein said string retaining apparatus is constantly pulled into a defined position on said string anchoring apparatus by the variable tension applied to said set of strings chiefly supported at said string nut and said bridge, said set of strings disposed mostly in parallel with each other, said string anchoring apparatus allowing for an option to have said set of strings anchored directly on said string anchoring apparatus of said instrument being operational without said string retaining apparatus and therefore without the functionality thereof.

13. The modular stringed instrument as in claim 12, wherein said arrangement of said machine tuners comprises said machine tuners arranged into a couple of arrays on said outer walls of said front and back lengthwise segments having said posts extending alternatingly from said outer walls into said window, said string holes proximally aligned on the medial line between said front and back lengthwise segments, and said buttons downwardly extending from said outer walls.

14. The modular stringed instrument as in claim 13, wherein the relative positions of said array of ball ends, said string retaining apparatus and said string anchoring apparatus are arranged in a class-two lever configuration of a neck-end lever structure, of which the fulcrum position is defined on said string anchoring apparatus, said array of ball ends represent the load position, and the effort position is defined on said string retaining apparatus to overcome the string tension upon removable attachment and reattachable removal of said tremolo module to and from said instrument.

15. The modular stringed instrument as in claim 14, wherein one or both of said expedited assembling steps and said expedited disassembling steps of said instrument comprise one or a plurality of steps to remove or to reinstall, or otherwise both as the case may be, such part of the string tension as required for said assembling or disassembling by manually actuating one or both of said pivotal tremolo functionality of said tremolo system and said neck-end lever structure.

16. The modular stringed instrument as in claim 15, wherein said lever comprising:
a couple of longitudinal side wall members that are in parallel with one another and symmetrical side to side;
a couple of rectangular saddle mount tabs that are symmetrical side to side and mostly in parallel with said saddle mount planes of said body module, and are respectively extending outwardly at the right angle from the bottom edges of said side wall members;
a top plate member having a front side and a back side, disposed mostly in parallel with said spring base plane of said body module, and said top plate member connecting said side wall members at the uppermost segments of said side wall members;
one or a plurality of compression springs providing said counterweight and attached alongside said back side of said top plate member, said compression springs mostly perpendicularly pushing against said spring base plane, and said compression springs being totally unloaded when the string tension is totally removed for the removal of said tremolo module from said body module, and said compression springs removed together with said tremolo module as the integral part thereof;
a couple of square knife-edge tabs respectively disposed symmetrically side to side, longitudinally extending outwardly at the right angle from the lowest segment of back longitudinal edges of said side wall members and inclining forwardly, said knife-edge tabs respectively having outer tapered edge segments and inner oblique edge segments at the uppermost edges thereof, said knife-edge tabs detachably attached to said Knife-edge mounting notches of said body module as said tremolo module constantly being pulled upwardly by the string tension.

17. The modular stringed instrument as in claim 15, wherein said string anchoring apparatus of said neck module having the shape of a plate with an uppermost pivotal edge, a front side and a back side, said string anchoring apparatus overlaying the back side of said crown and defining the upper end of said neck module with said pivotal edge, comprising a lateral array of a plurality of longitudinal string slots respectively having open ends at said pivotal edge of said string anchoring apparatus, said string slots respectively disposed at mostly the same intervals as the intervals between said nut grooves of said string nut.

18. The modular stringed instrument as in claim 15, wherein said string retaining apparatus having the shape of a plate with an uppermost lever edge, a front and a back sides, and a bottom end, said lever edge of said string retaining apparatus disposed upwardly exceeding said pivotal edge of said string anchoring apparatus of said modular stringed instrument as assembled, the string retaining apparatus comprising;
a lateral array of string apertures disposed alongside said uppermost edge of said string retaining apparatus, said string apertures respectively and closely aligned with said string slots of said string anchoring apparatus, the string apertures respectively holding said set of strings passing through said string apertures to the front side of said string retaining apparatus with said ball ends anchored on said string apertures at said back side of said string retaining apparatus an integrated lever tab of said neck-end lever structure at said bottom end of said string retaining apparatus, said lever tab leveraging the manually applied force to said lever tab for attaching or detaching said set of strings into or out of the corresponding bottom ends of said string slots of said string anchoring apparatus by radially pivoting up around an axis defined by said pivotal edge of said string anchoring apparatus to overcome a part of string tension that is obliquely pulling the set of strings downwardly to said front side of said string anchoring apparatus, thereby holding said set of strings at said bottom ends of said string slots.

19. The modular stringed instrument as in claim 14, wherein said modular stringed instrument is assembled and disassembled according to one or both of said option to remove and exclude said lever from said tremolo module as aforesaid, and said option to remove and exclude said string retaining apparatus of said tremolo module from said tremolo module as aforesaid.
